(19) United States
(12) Patent Application Publication
(10) Pub. No.: US 2025/0159348 A1
(43) Pub. Date: May 15, 2025

(54) ELECTRONIC DEVICE FOR ACQUIRING IMAGE BY USING MULTIPLE CAMERAS AND METHOD THEREFOR

(71) Applicant: Samsung Electronics Co., Ltd., Suwon-si (KR)

(72) Inventors: Inho JEONG, Suwon-si (KR); Sungkoo LEE, Suwon-si (KR); Daejong NOH, Suwon-si (KR); Yongkwan KIM, Suwon-si (KR); Jaemu YUN, Suwon-si (KR); Seungtae HA, Suwon-si (KR)

(21) Appl. No.: 19/024,980

(22) Filed: Jan. 16, 2025

Related U.S. Application Data
(63) Continuation of application No. PCT/KR2023/009205, filed on Jun. 30, 2023.

(30) Foreign Application Priority Data
Jul. 26, 2022 (KR) 10-2022-0092337
Sep. 21, 2022 (KR) 10-2022-0119574

(51) Int. Cl. H04N 23/68; H04N 23/69; H04N 23/90

(52) U.S. Cl. CPC H04N 23/687; H04N 23/69; H04N 23/90

(57) ABSTRACT

An electronic device is provided. The electronic device includes a plurality of cameras disposed at different positions on one side of the electronic device, a display, memory storing one or more computer programs, and one or more processors communicatively coupled to the plurality of cameras, the display, and the memory, wherein the one or more computer programs include computer-executable instructions that, when executed by the one or more processors individually or collectively, cause the electronic device to while displaying an image acquired through a first camera among the plurality of cameras on the display, receive a user input corresponding to a zoom operation for changing magnification for capturing the image, determine at least one camera among the plurality of cameras based on the magnification to be changed by the zoom operation, determine at least one control value for controlling an optical image stabilization module of each of the at least one camera based on a position of each of the at least one camera on the one side, based on the at least one control value, control the optical image stabilization module of each of the at least one camera to move an optical system or an image sensor of each of the at least one camera in a direction of moving a position of a subject presented in the image captured by the at least one camera, and while performing the zoom operation, control the display to switch an image displayed on the display from the image acquired through the first camera to an image acquired through another camera while the optical system or the image sensor of each of the at least one camera is moved based on the at least one control value.

### CROSS-REFERENCE TO RELATED APPLICATION(S)

This application is a continuation application, claiming priority under 35 U.S.C. § 365 (c), of an International application No. PCT/KR2023/009205, filed on Jun. 30, 2023, which is based on and claims the benefit of a Korean patent application number 10-2022-0092337, filed on Jul. 26, 2022, in the Korean Intellectual Property Office, and of a Korean patent application number 10-2022-0119574, filed on Sep. 21, 2022, in the Korean Intellectual Property Office, the disclosure of each of which is incorporated by reference herein in its entirety.

### BACKGROUND

### 1. Field

The disclosure relates to an electronic device for acquiring an image using a plurality of cameras and an operating method of the electronic device.

### 2. Description of Related Art

As a digital camera is improved in performance and miniaturized in size, various electronic devices equipped with the camera may be provided. An electronic device equipped with the camera may provide an image capturing function. For example, the electronic device may output a live preview screen on a display using an image obtained from the camera, and store the image obtained from the camera in memory if receiving a user input for the image capturing.

The electronic device may include a plurality of cameras. For example, the electronic device may include a plurality of cameras having different characteristics. The electronic device may provide a function of capturing a subject in various manners using the plurality of cameras. For example, the electronic device may switch the camera used to obtain the image according to optical magnification to acquire the image with more improved quality if zooming in or out the image.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device for acquiring an image using a plurality of cameras and an operating method of the electronic device.

Additional aspects will be set forth in part in the description which follows and, in part, will be apparent from the description, or may be learned by practice of the presented embodiments.

In accordance with an aspect of the disclosure, an electronic device is provided. The electronic device includes a plurality of cameras disposed at different positions on one side of the electronic device, a display, memory storing one or more computer programs, and one or more processors communicatively coupled to the plurality of cameras, the display, and the memory, wherein the one or more computer programs include computer-executable instructions that, when executed by the one or more processors individually or collectively, cause the electronic device to, while displaying an image acquired through a first camera among the plurality of cameras on the display, receive a user input corresponding to a zoom operation for changing magnification for capturing the image, determine at least one camera among the plurality of cameras based on the magnification to be changed by the zoom operation, determine at least one control value for controlling an optical image stabilization module of each of the at least one camera based on a position of each of the at least one camera on the one side, based on the at least one control value, control the optical image stabilization module of each of the at least one camera to move an optical system or an image sensor of each of the at least one camera in a direction of moving a position of a subject presented in the image captured by the at least one camera, while performing the zoom operation, control the display to switch an image displayed on the display from the image acquired through the first camera to an image acquired through another camera while the optical system or the image sensor of each of the at least one camera is moved based on the at least one control value.

In accordance with another aspect of the disclosure, a method of operating an electronic device is provided. The method includes, while displaying an image acquired through a first camera among a plurality of cameras on a display, receiving, by the electronic device, a user input corresponding to a zoom operation for changing magnification for capturing the image, determining, by the electronic device, at least one camera among the plurality of cameras based on the magnification to be changed by the zoom operation, determining, by the electronic device, at least one control value for controlling an optical image stabilization module of each of the at least one camera based on a position of each of the at least one camera on the one side of the electronic device, based on the at least one control value, controlling, by the electronic device, the optical image stabilization module of each of the at least one camera to move an optical system or an image sensor of each of the at least one camera in a direction for moving a position of a subject presented in the image captured by the at least one camera, and while performing the zoom operation, controlling, by the electronic device, the display to switch an image displayed on the display from the image acquired through the first camera to an image acquired through other camera while the optical system or the image sensor of each of the at least one camera is moved based on the at least one control value.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include while displaying an image acquired through a first camera among a plurality of cameras on a display, receiving, by the electronic device, a user input corresponding to a zoom operation for changing magnification for capturing the image, determining, by the electronic device, at least one camera among the plurality of cameras based on the magnification to be changed by the zoom operation, determining, by the electronic device, at least one control value for controlling an optical image stabilization module of each of the at least one camera based on a position of each of the at least one camera on the one side of the electronic device, based on the at least one control value, controlling, by the electronic device, the optical image stabilization module of each of the at least one camera to move an optical system or an image sensor of each of the at least one camera in a direction for moving a position of a subject presented in the image captured by the at least one camera and while performing the zoom operation, controlling, by the electronic device, the display to switch an image displayed on the display from the image acquired through the first camera to an image acquired through other camera while the optical system or the image sensor of each of the at least one camera is moved based on the at least one control value.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device in a network environment according to an embodiment of the disclosure;

FIG. 2 is a block diagram illustrating a camera module according to an embodiment of the disclosure;

FIG. 3 is a diagram illustrating an exterior of an electronic device according to an embodiment of the disclosure;

FIG. 4 is a diagram illustrating cameras arranged in a camera area of an electronic device according to an embodiment of the disclosure;

FIG. 5 is a diagram illustrating a camera module included in an electronic device according to an embodiment of the disclosure;

FIG. 6 is a diagram illustrating a camera module included in an electronic device according to an embodiment of the disclosure;

FIG. 7 is a diagram for illustrating an operation of an electronic device for moving a position of a subject displayed on an image sensor according to an embodiment of the disclosure;

FIG. 8 is a diagram for illustrating a change of an image according to lens movement according to an embodiment of the disclosure;

FIG. 9 is a flowchart illustrating a process for operating an electronic device according to an embodiment of the disclosure;

FIG. 10 is a diagram illustrating an electronic device switches a camera used to acquire an image from a first camera to a second camera in response to receiving a zoom-in input according to an embodiment of the disclosure;

FIG. 11 is a flowchart illustrating a process after a zoom operation of an electronic device according to an embodiment of the disclosure;

FIG. 12 is a diagram illustrating an operation of an electronic device after a zoom operation according to an embodiment of the disclosure;

FIG. 13 is a flowchart illustrating a process in which an electronic device determines a control value for controlling an optical image stabilization module according to an embodiment of the disclosure;

FIG. 14 is a diagram for illustrating position movement of a subject image in an image based on a distance to a subject according to an embodiment of the disclosure;

FIG. 15 is a flowchart illustrating a process in which an electronic device determines at least one camera according to an embodiment of the disclosure;

FIG. 16 is a diagram illustrating a method for an electronic device to move a lens of at least one camera while performing a zoom-in operation to change magnification according to an embodiment of the disclosure;

FIG. 17 is a diagram illustrating a method for an electronic device to move a lens of at least one camera while performing a zoom-in operation for different magnification according to an embodiment of the disclosure;

FIG. 18 is a flowchart illustrating a process in which an electronic device determines at least one camera according to an embodiment of the disclosure;

FIG. 19 is a diagram illustrating a method for an electronic device to move a lens of at least one camera while performing a zoom-in operation to change magnification according to an embodiment of the disclosure;

FIG. 20 is a diagram illustrating a method for an electronic device to move a lens of at least one camera while performing a zoom-in operation for different magnification according to an embodiment of the disclosure;

FIG. 21 is a flowchart illustrating a process in which an electronic device determines at least one camera according to an embodiment of the disclosure;

FIG. 22 is a diagram illustrating a method for an electronic device to move a lens of at least one camera while performing a zoom-in operation to change magnification according to an embodiment of the disclosure;

FIG. 23 is a diagram illustrating a method for an electronic device to move a lens of at least one camera while performing a zoom-in operation for different magnification according to an embodiment of the disclosure;

FIG. 24 is a diagram illustrating a method for an electronic device to move a lens of at least one camera while performing a zoom-in operation using four cameras according to an embodiment of the disclosure;

FIG. 25 is a diagram illustrating a method for an electronic device to move a lens of at least one camera while performing a zoom-in operation using four cameras according to an embodiment of the disclosure;

FIG. 26 is a diagram illustrating a method for an electronic device to control cameras arranged in a square while performing a zoom operation according to an embodiment of the disclosure; and

FIG. 27 is a diagram illustrating a method for an electronic device to control cameras arranged in a triangle while performing a zoom operation according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

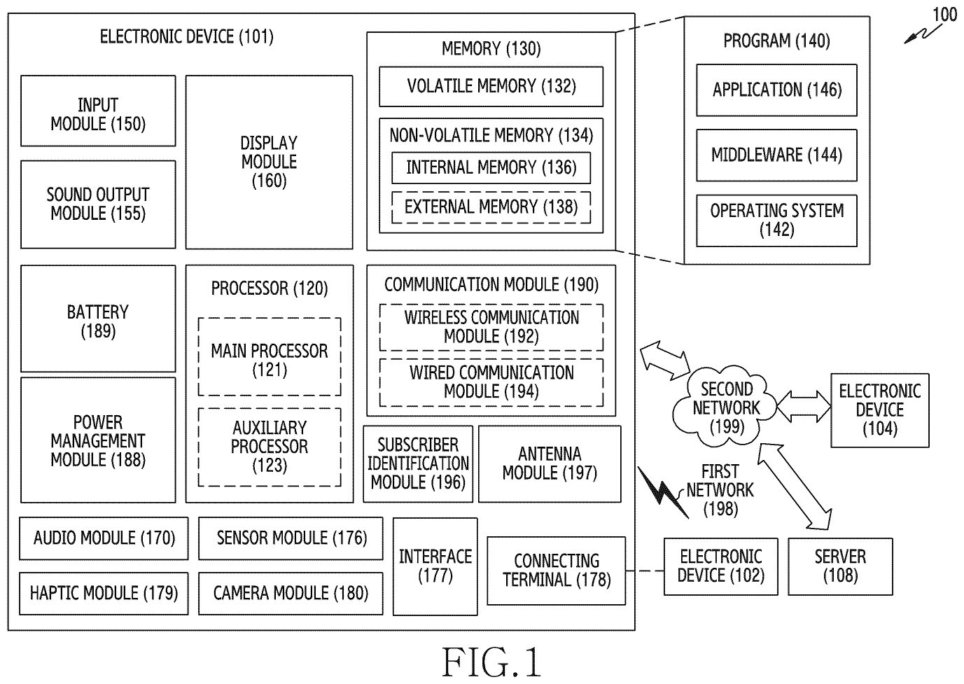

FIG. 1 is a block diagram illustrating an electronic device in a network environment according to an embodiment of the disclosure.

Referring to FIG. 1, an electronic device 101 in a network environment 100 may communicate with an external electronic device 102 via a first network 198 (e.g., a short-range wireless communication network), or at least one of an external electronic device 104 or a server 108 via a second network 199 (e.g., a long-range wireless communication network). According to an embodiment of the disclosure, the electronic device 101 may communicate with the external electronic device 104 via the server 108. According to an embodiment of the disclosure, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments of the disclosure, at least one of the components (e.g., the connecting terminal 178) may be omitted from the electronic device 101, or one or more other components may be added in the electronic device 101. In some embodiments of the disclosure, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment of the disclosure, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment of the disclosure, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., a sleep) state, or together with the main processor 121 while the main processor 121 is in an active state (e.g., executing an application). According to an embodiment of the disclosure, the auxiliary processor 123 (e.g., an image signal processor or a communication processor) may be implemented as part of another component (e.g., the camera module 180 or the communication module 190) functionally related to the auxiliary processor 123. According to an embodiment of the disclosure, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thererto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment of the disclosure, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment of the disclosure, the display module 160 may include a touch sensor adapted to detect a touch, or a pressure sensor adapted to measure the intensity of force incurred by the touch.

The audio module 170 may convert a sound into an electrical signal and vice versa. According to an embodiment of the disclosure, the audio module 170 may obtain the sound via the input module 150, or output the sound via the sound output module 155 or a headphone of an external electronic device (e.g., the external electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment of the disclosure, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the external electronic device 102) directly (e.g., wiredly) or wirelessly. According to an embodiment of the disclosure, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the external electronic device 102). According to an embodiment of the disclosure, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment of the disclosure, the haptic module 179 may include, for example, a motor, a piezoelectric element, or an electric stimulator.

The camera module 180 may capture a still image or moving images. According to an embodiment of the disclosure, the camera module 180 may include one or more lenses, image sensors, image signal processors, or flashes.

The power management module 188 may manage power supplied to the electronic device 101. According to one embodiment of the disclosure, the power management module 188 may be implemented as at least part of, for example, a power management integrated circuit (PMIC).

The battery 189 may supply power to at least one component of the electronic device 101. According to an embodiment of the disclosure, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the external electronic device 102, the external electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment of the disclosure, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mm Wave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the external electronic device 104), or a network system (e.g., the second network 199). According to an embodiment of the disclosure, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment of the disclosure, the antenna module 197 may include an antenna including a radiating element including a conductive material or a conductive pattern formed in or on a substrate (e.g., a printed circuit board (PCB)). According to an embodiment of the disclosure, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment of the disclosure, another component (e.g., a radio frequency integrated circuit (RFIC)) other than the radiating element may be additionally formed as part of the antenna module 197.

According to various embodiments of the disclosure, the antenna module 197 may form a mm Wave antenna module. According to an embodiment of the disclosure, the mm Wave antenna module may include a printed circuit board, a RFIC disposed on a first surface (e.g., the bottom surface) of the printed circuit board, or adjacent to the first surface and capable of supporting a designated high-frequency band (e.g., the mm Wave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment of the disclosure, commands or data may be transmitted or received between the electronic device 101 and the external electronic device 104 via the server 108 coupled with the second network 199. Each of the external electronic devices 102 or 104 may be a device of a same type as, or a different type, from the electronic device 101. According to an embodiment of the disclosure, all or some of operations to be executed at the electronic device 101 may be executed at one or more of the external electronic devices 102 or 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment of the disclosure, the external electronic device 104 may include an Internet-of-things (IoT) device. The server 108 may be an intelligent server using machine learning and/or a neural network. According to an embodiment of the disclosure, the external electronic device 104 or the server 108 may be included in the second network 199. The electronic device 101 may be applied to intelligent services (e.g., a smart home, a smart city, a smart car, or healthcare) based on 5G communication technology or IoT-related technology.

The electronic device according to various embodiments of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment of the disclosure, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment of the disclosure, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments of the disclosure, each component (e.g., a module or a program) of the above-described components may include a single entity or multiple entities, and some of the multiple entities may be separately disposed in different components. According to various embodiments of the disclosure, one or more of the above-described components may be omitted, or one or more other components may be added. Alternatively or additionally, a plurality of components (e.g., modules or programs) may be integrated into a single component. In such a case, according to various embodiments of the disclosure, the integrated component may still perform one or more functions of each of the plurality of components in the same or similar manner as they are performed by a corresponding one of the plurality of components before the integration. According to various embodiments of the disclosure, operations performed by the module, the program, or another component may be carried out sequentially, in parallel, repeatedly, or heuristically, or one or more of the operations may be executed in a different order or omitted, or one or more other operations may be added.

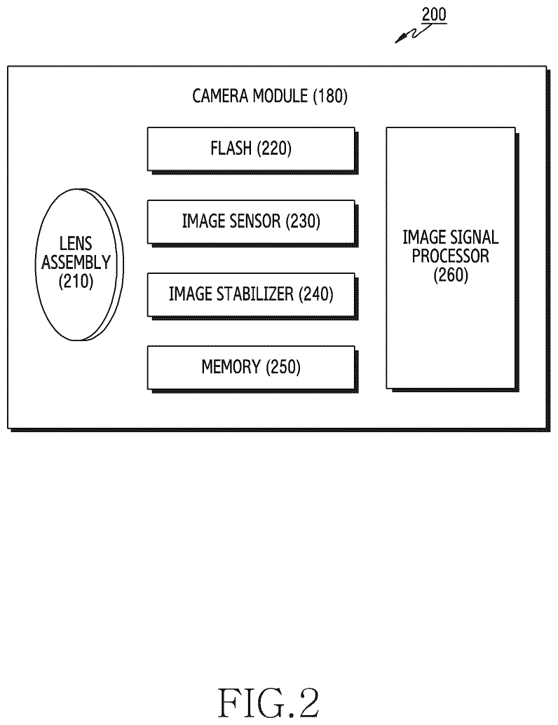

FIG. 2 is a block diagram 200 illustrating a camera module according to an embodiment of the disclosure.

Referring to FIG. 2, the camera module 180 may include a lens assembly 210, a flash 220, an image sensor 230, an image stabilizer 240, memory 250 (e.g., buffer memory), or an image signal processor 260. The lens assembly 210 may collect light emitted or reflected from an object whose image is to be taken. The lens assembly 210 may include one or more lenses. According to an embodiment of the disclosure, the camera module 180 may include a plurality of lens assemblies 210. In such a case, the camera module 180 may form, for example, a dual camera, a 360-degree camera, or a spherical camera. Some of the plurality of lens assemblies 210 may have the same lens attribute (e.g., view angle, focal length, auto-focusing, f number, or optical zoom), or at least one lens assembly may have one or more lens attributes different from those of another lens assembly. The lens assembly 210 may include, for example, a wide-angle lens or a telephoto lens.

The flash 220 may emit light that is used to reinforce light reflected from an object. According to an embodiment of the disclosure, the flash 220 may include one or more light emitting diodes (LEDs) (e.g., a red-green-blue (RGB) LED, a white LED, an infrared (IR) LED, or an ultraviolet (UV) LED) or a xenon lamp. The image sensor 230 may obtain an image corresponding to an object by converting light emitted or reflected from the object and transmitted via the lens assembly 210 into an electrical signal. According to an embodiment of the disclosure, the image sensor 230 may include one selected from image sensors having different attributes, such as a RGB sensor, a black-and-white (BW) sensor, an IR sensor, or a UV sensor, a plurality of image sensors having the same attribute, or a plurality of image sensors having different attributes. Each image sensor included in the image sensor 230 may be implemented using, for example, a charged coupled device (CCD) sensor or a complementary metal oxide semiconductor (CMOS) sensor.

The image stabilizer 240 may move the image sensor 230 or at least one lens included in the lens assembly 210 in a particular direction, or control an operational attribute (e.g., adjust the read-out timing) of the image sensor 230 in response to the movement of the camera module 180 or the electronic device 101 including the camera module 180. This allows compensating for at least part of a negative effect (e.g., image blurring) by the movement on an image being captured. According to an embodiment of the disclosure, the image stabilizer 240 may detect such a movement by the camera module 180 or the electronic device 101 using a gyro sensor (not shown) or an acceleration sensor (not shown) disposed inside or outside the camera module 180. According to an embodiment of the disclosure, the image stabilizer 240 may be implemented, for example, as an optical image stabilizer.

The memory 250 may store, at least temporarily, at least part of an image obtained via the image sensor 230 for a subsequent image processing task. For example, if image capturing is delayed due to shutter lag or multiple images are quickly captured, a raw image obtained (e.g., a Bayer-patterned image, a high-resolution image) may be stored in the memory 250, and its corresponding copy image (e.g., a low-resolution image) may be previewed via the display module 160. Thereafter, if a specified condition is met (e.g., by a user's input or system command), at least part of the raw image stored in the memory 250 may be obtained and processed, for example, by the image signal processor 260. According to an embodiment of the disclosure, the memory 250 may be configured as at least part of the memory 130 or as separate memory that is operated independently from the memory 130. The image signal processor 260 may perform one or more image processing with respect to an image obtained via the image sensor 230 or an image stored in the memory 250. The one or more image processing may include, for example, depth map generation, three-dimensional (3D) modeling, panorama generation, feature point extraction, image synthesizing, or image compensation (e.g., noise reduction, resolution adjustment, brightness adjustment, blurring, sharpening, or softening). Additionally or alternatively, the image signal processor 260 may perform control (e.g., exposure time control or read-out timing control) with respect to at least one (e.g., the image sensor 230) of the components included in the camera module 180. An image processed by the image signal processor 260 may be stored back in the memory 250 for further processing, or may be provided to an external component (e.g., the memory 130, the display module 160, the external electronic device 102, the external electronic device 104, or the server 108) outside the camera module 180. According to an embodiment of the disclosure, the image signal processor 260 may be configured as at least part of the processor 120, or as a separate processor that is operated independently from the processor 120. If the image signal processor 260 is configured as a separate processor from the processor 120, at least one image processed by the image signal processor 260 may be displayed, by the processor 120, via the display module 160 as it is or after being further processed.

According to an embodiment of the disclosure, the electronic device 101 may include a plurality of camera modules 180 having different attributes or functions. In such a case, at least one of the plurality of camera modules 180 may form, for example, a wide-angle camera and at least another of the plurality of camera modules 180 may form a telephoto camera. Similarly, at least one of the plurality of camera modules 180 may form, for example, a front camera and at least another of the plurality of camera modules 180 may form a rear camera.

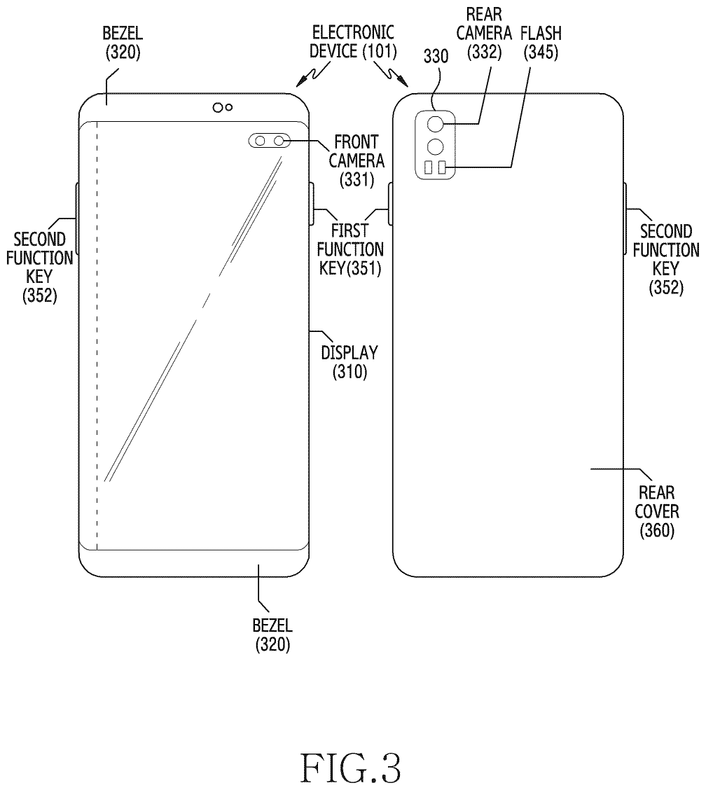

FIG. 3 is a diagram illustrating an exterior of an electronic device according to an embodiment of the disclosure.

Referring to FIG. 3, a display 110 may be disposed on a front side of the electronic device 101 according to an embodiment. In the example shown in FIG. 1, the display 310 may occupy most of the front side of the electronic device 101. The display 310 and a bezel area 320 surrounding at least a part of an edge of the display 310 may be disposed on the front side of the electronic device 101.

In an embodiment of the disclosure, a front camera 331 may be disposed in the front side of the electronic device 101. The example shown in FIG. 3 shows that the front camera 331 is exposed through one area of the display 310, but the front camera 33 1 may be disposed to be exposed through the bezel 320.

The electronic device 101 may include one or more front cameras 331. For example, the electronic device 101 may include a first front camera and a second front camera. The first front camera and the second front camera may be cameras of the same type with equivalent specifications (e.g., pixels or an angle of view), but may also be implemented with cameras of different specifications. The electronic device 101 may support a function (e.g., three-dimensional (3D) shooting, auto focus, or the like) related to dual cameras through the two front cameras.

A rear camera 332 may be disposed in a rear side of the electronic device 101. The rear camera 332 may be exposed through a camera area 330 of a rear cover 360. The electronic device 101 may include a plurality of rear cameras disposed in the camera area 330. For example, the electronic device 101 may include two or more rear cameras. For example, the electronic device 101 may include a first rear camera, a second rear camera, and a third rear camera. The first rear camera, the second rear camera, and the third rear camera may have different specifications. For example, a field of view (FOV), pixels, an aperture, whether optical zoom/digital zoom are supported, whether an optical image stabilizer (OIS) function is supported, and type and arrangement of a lens set (e.g., the lens assembly 210 of FIG. 2) included in each camera of the first rear camera, the second rear camera, and/or the third rear camera may differ from each other. For example, the first rear camera may be a general camera, the second rear camera may be a camera for wide shooting, and the third rear camera may be a camera for telephoto. In this document, description on the function or the characteristics of the front camera may be applied to the rear camera and vice versa.

Additional hardware or sensor for assisting the image capturing may be disposed in the camera area 330. For example, the camera area 330 may further include a flash 345 for providing a light source. As another example, the camera area 330 may further include a distance sensor (e.g., a time of flight (TOF) sensor, a depth sensor, a range sensor, a laser sensor, photo diode pixels, a stereo camera) for detecting a distance between the subject and the electronic device 101. However, it is not limited thereto.

At least one physical key may be disposed on a side portion of the electronic device 101. For example, a first function key 351 for turning on/off the display 310 or turning on/off power of the electronic device 101 may be disposed in a right edge based on the front side of the electronic device 101. A second function key 352 for controlling volume or screen brightness of the electronic device 101 may be disposed in a left edge based on the front side of the electronic device 101. Besides, an additional button or key may be disposed in the front side or the rear side of the electronic device 101. For example, a physical button or a touch button which may be mapped to at least one function may be disposed in a lower area of a front bezel.

The electronic device 101 may include a processor, a display, memory, and one or more camera modules. The processor may execute an application supporting the image capturing function. In addition, the processor may execute one or more camera modules and set and support an appropriate shooting mode such that one or more camera modules may perform an operation intended by a user. An application associated with one or more camera modules may be stored in the memory. Each camera module may include a lens set including at least one lens.

The electronic device 101 may use one or more hardware processing circuits to perform various functions and operations disclosed in this document. For example, an application processor included in a mobile device, an image signal processor (ISP) mounted in a camera module, a display driver integrated circuit (DDIC), or a hardware encoder may be used to implement embodiments disclosed in this document. In this document, the processor may be understood as including one or more hardware processing circuits.

However, the exterior of the electronic device 101 shown in FIG. 3 is illustrated as an example, and the hardware configuration of the electronic device 101 is not limited thereto. Some of the components shown in FIG. 3 may be excluded from the electronic device 101. The electronic device 101 may further include a component not shown in FIG. 3. For example, the electronic device 101 may have the form of a foldable electronic device in which the display 110 is foldable. As another example, the electronic device 101 may have a rollable or unfoldable display 110. As yet another example, the number and the arrangement of the cameras included in the camera module (e.g., the front camera 331 or the rear camera 332) disposed in the electronic device 101 may modified in various manners. Alternatively, the technical idea disclosed in this document may be also applied to a mobile device or a portable device, such as a tablet or a laptop.

Hereafter, for convenience of explanation, description is provided based on the electronic device 101 having the camera area 330 shown in FIG. 3.

The electronic device 101 according to an embodiment of the disclosure may include a processor (e.g., the processor 120 of FIG. 1), a camera (e.g., the camera module 180 of FIG. 1 or FIG. 2, the front camera 331 or the rear camera 332 of FIG. 3), a display (e.g., the display module 160 of FIG. 1, the display 310 of FIG. 3) and memory (e.g., the memory 130 of FIG. 1). The electronic device 101 may further include an additional component, or may omit some component.

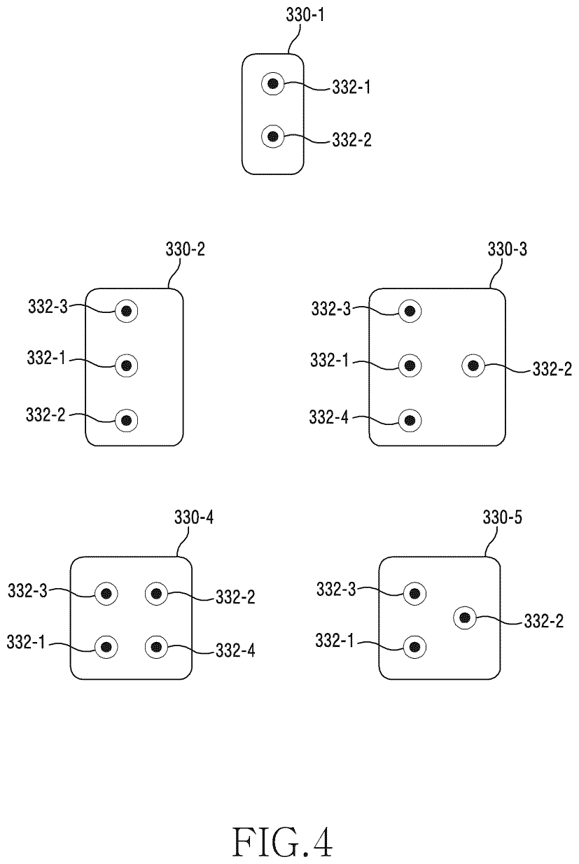

FIG. 4 is a diagram illustrating a camera disposed in a camera area of an electronic device according to an embodiment of the disclosure.

Referring to FIG. 4, the electronic device 101 according to an embodiment of the disclosure may include a plurality of photographing means including an image stabilization means (e.g., the image stabilizer 240 of FIG. 2). For example, a camera area 330-1 of the electronic device 101 according to an embodiment of the disclosure may include a first camera 332-1 and a second camera 332-2. The first camera 332-1 may be a camera for wide shooting. The second camera 332-2 may be a camera for telephoto. The first camera 332-1 may be a camera supporting a wider angle of view (or, having a shorter focal length, or lower magnification) than the second camera 332-2.

A camera area 330-2 of the electronic device may include the first camera 332-1, the second camera 332-2, and a third camera 332-3. The third camera 332-3 may be a camera supporting a wider angle of view (or, having a shorter focal length, or lower magnification) than the first camera 332-1. The first camera 332-1, the second camera 332-2 and the third camera 332-3 may be arranged in a row as shown in the camera area 330-2 of FIG. 4. Alternatively, the first camera 332-1, the second camera 332-2 and the third camera 332-3 may be arranged to form a triangle with lines connecting each camera as shown in a camera area 330-5 of FIG. 4.

A camera area 330-3 of the electronic device may include the first camera 332-1, the second camera 332-2, the third camera 332-3 and a fourth camera 332-4. The fourth camera 332-4 may be a camera supporting a narrower angle of view (or, having a longer focal length, or higher magnification) than the third camera 332-3. The first camera 332-1, the second camera 332-2, the third camera 332-3 and the fourth camera 332-4 may be arranged in a T shape as shown in the camera area 330-3 of FIG. 4. Alternatively, the first camera 332-1, the second camera 332-2, the third camera 332-3 and the fourth camera 332-4 may be arranged to form a square with lines connecting each camera shown in a camera area 330-4 in FIG. 4.

For example, the first camera 332-1 may be a wide-angle camera supporting the wide shooting. For example, the second camera 332-2 may be a telephoto camera supporting telephoto photography. For example, the third camera 332-3 may be an ultra-wide angle camera supporting a wider angle of view photography than the first camera. For example, the fourth camera 332-4 may be a telephoto camera with a longer focal length than the second camera 332-2. However, it is not limited thereto.

FIG. 4 illustrates cameras arranged in an electronic device and a camera arrangement is not limited to forms as shown in FIG. 4 according to an embodiment of the disclosure. More cameras than those shown in FIG. 4 may be disposed in the camera area 330. The cameras may be arranged in various forms depending on the number and the type of cameras.

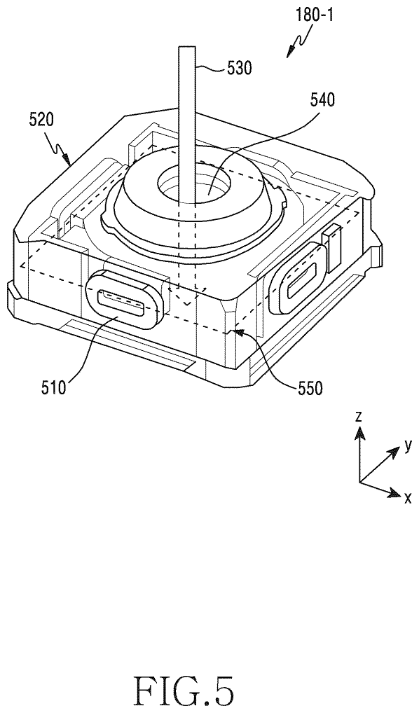

FIG. 5 is a diagram illustrating a camera module included in an electronic device according to an embodiment of the disclosure.

Referring to FIG. 5, the camera module 180-1 according to an embodiment of the disclosure may include a y-axis optical image stabilization (OIS) actuator 510 and an x-axis OIS actuator 520 for configuring an OIS module (e.g., the image stabilizer 240 of FIG. 2). By applying an electric current to a coil included in the y-axis OIS actuator 510, the y-axis OIS actuator 510 may move a carrier accommodating a lens 540 (e.g., the lens assembly 210 of FIG. 2) and attached with a magnet in a +y-axis direction or −y-axis direction. By applying an electric current to a coil included in the x-axis OIS actuator 520, the x-axis OIS actuator 520 may move the carrier accommodating the lens 540 and attached with the magnet in a +x-axis direction or −x-axis direction.

The camera module 180-1 may include an image sensor 550 (e.g., the image sensor 230 of FIG. 2) for detecting light which passes through the lens 540 and is incident in a −z-axis direction through an optical path 530. The electronic device 101 may move a position of an image detected through the image sensor in the +x-axis and/or +y-axis by controlling the y-axis OIS actuator 510 and the x-axis OIS actuator 520.

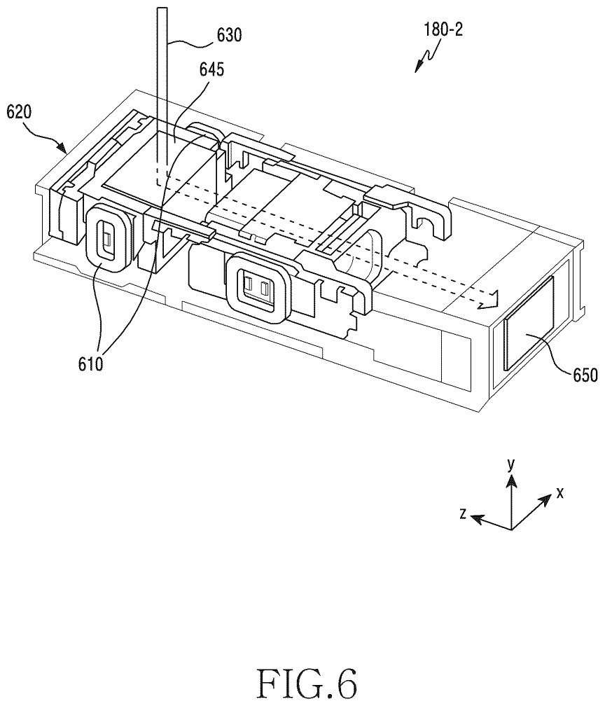

FIG. 5 illustrate a configuration of the camera module 180-1, and the configuration of the camera module 180-1 may be applied in various manners. For example, the OIS module of the camera module 180-1 may be configured to move the position of the image sensor 550 rather than the lens 540. Alternatively, the camera of the electronic device may include a folded camera, such as the camera module 180-2 of FIG. 6, in which an optical path 630 of light incident onto an image sensor 650 is bent one or more times.

FIG. 6 is a diagram illustrating a camera module included in an electronic device according to an embodiment of the disclosure.

Referring to FIG. 6, as for a camera module with a long focal distance from the lens to the image sensor 650, it is difficult to implement in the form shown in FIG. 5, to equip the camera module in a thin device. Hence, the camera module 180-2 may include an optical system (e.g., a prism 645 or a mirror) for refracting the optical path 630 one or more times.

The camera module 180-2 may include an x-axis OIS actuator 610 for moving the position of an image acquired through the image sensor 650 in the x-axis direction and a y-axis OIS actuator 620. The x-axis OIS actuator 610 and the y-axis OIS actuator 620 may be configured as actuators for rotating in yaw or pitch axis directions. The x-axis OIS actuator 610 for moving in the x-axis direction and the y-axis OIS actuator 620 may tilt a prism 645 to move the image acquired through the image sensor 650 in the x-axis or y-axis direction.

However, the camera module 180-1 or 180-2 in the form as shown in FIG. 5 or FIG. 6 is not necessarily included in the electronic device 101, and the electronic device 101 may include at least one or more camera modules including other type of the OIS module. For example, the electronic device 101 may include a camera module including an OIS module which moves the image sensor rather than the lens. This document focuses on the structure of the OIS module for moving the position of the lens for convenience of explanation, but the same technical features may be applied to other type of the OIS module.

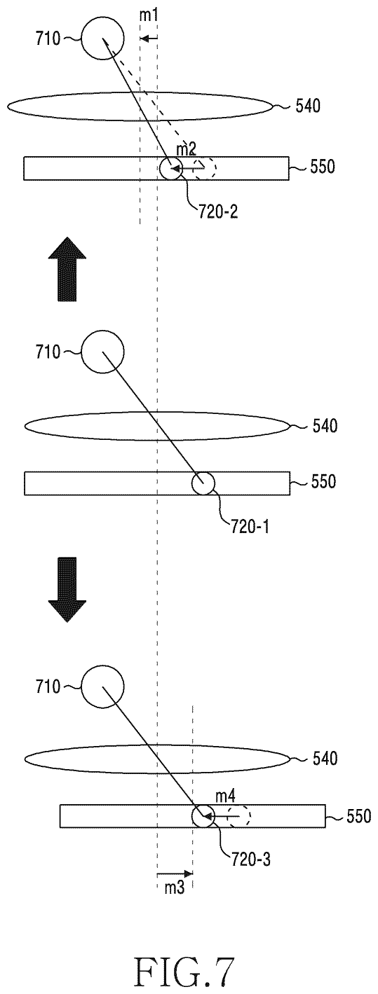

FIG. 7 is a diagram for illustrating an operation of an electronic device for moving a position of a subject presented on an image sensor according to an embodiment of the disclosure.

Referring to FIG. 7, it shows the operation of the electronic device 101 based on a case where the OIS module (e.g., the image stabilizer 240 of FIG. 2) of the camera module 180 included in the electronic device 101 includes an actuator of a lens shift type which moves the position of the lens 540 to move a position 720-1 of the subject 710 formed on the image sensor 550. However, the camera module 180 included in the electronic device 101 according to an embodiment is not limited to including the lens shift type actuator. For example, the OIS module (e.g., the image stabilizer 240 of FIG. 2) may include at least one of a sensor shift type actuator for moving the image sensor, a module tilting type actuator for tilting an orientation of the camera module 180 or a prism tilting type actuator for tilting a prism (e.g., the prism 645 of FIG. 6). Regardless of the type of the actuator included in the OIS module (e.g., the image stabilizer 240 of FIG. 2) of the camera module 180, the electronic device 101 may operate to move the position 720-1 of the image of the subject 710 formed on the image sensor 550.

Referring to FIG. 7, the image of the subject 710 may be formed at the first position 720-1 on the image sensor 550, if there is no offset applied to the position of the lens 540 (e.g., the lens assembly 210 of FIG. 2) due to the OIS module (e.g., the image stabilizer 240 of FIG. 2 or the OIS actuators 510 and 520 of FIG. 5) of the camera module 180.

If the lens 540 moves in a first direction ml by the OIS module, the shape of the subject 710 formed on the image sensor 550 may be formed at a second position 720-2 on the image sensor 550 by moving in a second direction m2 in parallel to the first direction m1. Since the image acquired through the image sensor 550 is presented by inverting the image formed on the image sensor 550, the shape mage of the subject may move in the opposite direction to the second direction m2 in the acquired image.

If the image sensor 550 moves in a third direction m3 by the OIS module, the shape of the subject 710 formed on the image sensor 550 may be formed on a third position 720-3 by moving in a fourth direction m4 which is substantially opposite to the third direction m3 on the image sensor 550. Since the image acquired through the image sensor 550 is presented as the inverted image formed on the image sensor 550, the shape of the subject may move in the third direction m3 in the acquired image.

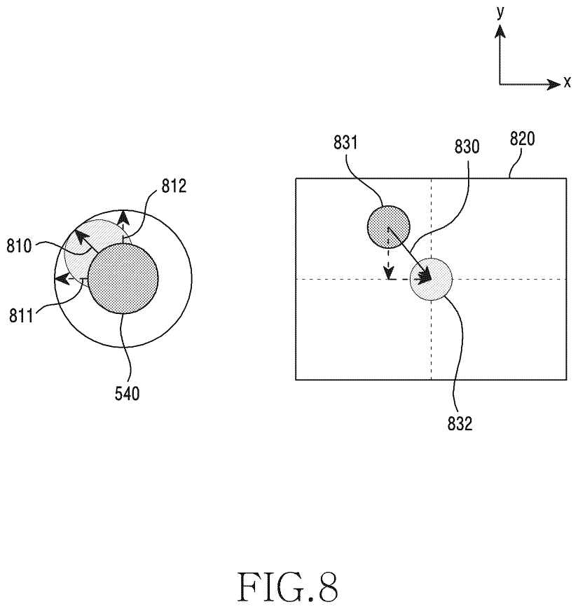

FIG. 8 is a diagram illustrating a change of an image according to movement of a lens according to an embodiment of the disclosure.

Referring to FIG. 8, the electronic device 101 according to an embodiment of the disclosure may control the OIS module to move the position of the lens 540 on an x-y axis plane. For example, the electronic device 101 may control an x-axis OIS actuator (e.g., the x-axis OIS actuator 520 of FIG. 5) to control position movement 811 of the lens 540 in the x-axis direction. In addition, the electronic device 101 may control a y-axis OIS actuator (e.g., the y-axis OIS actuator 510 of FIG. 5) to control a position 812 of the lens 540 in the y-axis direction. The electronic device 101 may move the lens 540 in a target movement direction 810 on the x-y axis plane through the position movement 811 in the x-axis direction and the position movement 812 in the y-axis direction.

With no offset applied to the lens 540 by the OIS module, the shape of the subject may be presented at a first position 831 in an image 820 acquired through the camera. If the lens 540 moves in the target movement direction 810 by the OIS module, the shape of the subject within the image 820 may be formed at a second position 832 which is moved in the opposite direction 830.

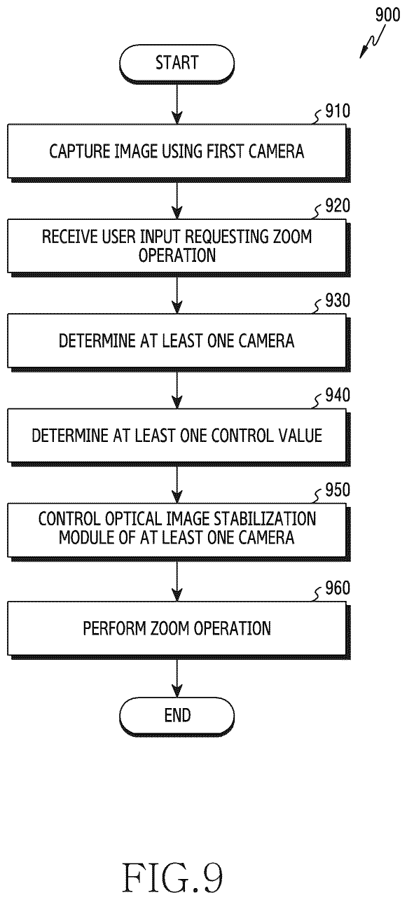

FIG. 9 is a flowchart 900 illustrating a process in which an electronic device operates according to an embodiment of the disclosure.

Referring to FIG. 9, operations of the electronic device 101 shown in the flowcharts shown in this document may be carried out by a processor (e.g., the processor 120 of FIG. 1) of the electronic device 101 by executing instructions stored in memory (e.g., the memory 130 of FIG. 1).

The electronic device 101 may include a plurality of cameras (e.g., at least two of the first camera 332-1, the second camera 332-2, the third camera 332-3 or the fourth camera 332-4 of FIG. 4) disposed at different positions on one side (e.g., the rear cover 360 of FIG. 3). In operation 910, the electronic device may capture an image using one or more of the plurality of cameras. For example, in response to execution of a camera application installed on the electronic device 101, the electronic device 101 may activate one or more of the plurality of cameras, and display a preview image presenting an image acquired through the activated camera in real time on the display (e.g., the display module 160 of FIG. 1). As another example, in response to a user input requesting to capture a video, the electronic device 101 may store images acquired through at least one of the plurality of cameras as a video. The electronic device 101 may display a preview image on the display while storing the video.

In operation 910, the electronic device 101 may capture an image using a camera corresponding to magnification which is set for the image capturing. For example, if the magnification set for the image capturing is 1.0×, the electronic device 101 may capture the image using a camera (e.g., the first camera 332-1 of FIG. 4) corresponding to the 1.0× magnification. As another example, if the magnification set for the image capturing is 20.0×, the electronic device 101 may capture the image using a camera (e.g., the fourth camera 332-4 of FIG. 4) corresponding to 20.0× magnification. The camera corresponding to the magnification may change depending on the configuration of the electronic device 101.

In operation 920, while displaying the image acquired through the camera, the electronic device 101 may receive a user input corresponding to a zoom operation for changing the magnification for the image capturing. For example, the electronic device 101 may display at least one icon for selecting the magnification together with the preview image captured by the camera on the display. While displaying the preview image at 1.0× magnification, the electronic device 101 may receive a touch input for selecting an icon corresponding to 10.0× magnification from at least one icon displayed on the screen. The type of the user input for performing the zoom operation may be implemented in various manners.

In operation 930, the electronic device 101 may determine at least one camera from the plurality of cameras based on the zoom operation corresponding to the user input. The electronic device 101 may determine at least one camera based on an interval in which the magnification is changed by the zoom operation. For example, if the zoom operation is an operation of changing the magnification from 0.5× magnification to 5.0× magnification, the electronic device 101 may select at least one camera from the first camera 332-1, the second camera 332-2 and the third camera 332-3 used to acquire images in the zoom operation of changing from 0.5× magnification to 5.0× magnification. As another example, if the zoom operation is an operation of changing the photography magnification from 1.0× magnification to 5.0× magnification, the electronic device 101 including the first camera 332-1 and the second camera 332-2 may select at least one camera from the first camera 332-1 and the second camera 332-2. The at least one camera determined may be a target to be controlled by the OIS module.

The electronic device may determine at least one camera from the plurality of cameras excluding some based on characteristics of each of the plurality of cameras included in the electronic device 101. For example, in a folded camera which provides the OIS function by tilting a prism, the image may roll if the OIS module operates to move the position of the image. Accordingly, the folded camera may be excluded from the at least one camera selected by the electronic device 101. As another example, a camera not including an OIS module may be excluded from at least one camera selected by the electronic device 101. However, the method for the electronic device 101 to determine at least one camera for controlling the OIS module is not limited thereto.

If the camera by the zoom operation used in the magnification change interval is excluded from at least one camera, the electronic device 101 may determine a crop area in the image acquired through the excluded camera by considering a relationship between the position of other camera (e.g., a camera used at the magnification at which the zoom operation starts) and the position of the excluded cameras. Image quality may deteriorate if the image is used by cropping some area, but the electronic device 101 may replace a part of the function performed by controlling the OIS module by changing the crop area in the image acquired through the excluded camera.

In operation 940, the electronic device 101 may determine at least one control value for controlling at least one camera determined. In an embodiment of the disclosure, at least one control value may include information for controlling the operation of the OIS module of at least one camera. For example, at least one control value may include a value for controlling the x-axis OIS actuator to move the lens of the camera by x-axis movement and a value for controlling the y-axis OIS actuator to move by y-axis movement by use of the OIS module. As another example, at least one control value may include information (e.g., coordinate values) of the position to which the lens of the camera is to be moved. However, it is not limited thereto, and the configuration of the control value may be implemented in various manners.

The control value may be determined to maintain the position of the subject or to limit the amount or the direction of the movement of the subject position in the camera switching by adjusting the position of the subject captured through at least one camera.

In operation 950, the electronic device 101 may control the OIS module for each of at least one camera based on the determined control value. For example, the electronic device 101 may control an OIS driver to supply a current (or, voltage or power) corresponding to the control value to a coil of the OIS actuator of the OIS module. The lens (or other optical system or image sensor) included in at least one camera may be moved in position by the operation of the OIS module.

In operation 960, the electronic device 101 may perform the zoom operation while the position of the lens (or other optical system or image sensor) included in at least one camera is moved. For example, the electronic device 101 may gradually enlarge or reduce the screen displayed on the display while performing the zoom operation. If the screen display magnification reaches a threshold while the screen displayed on the display is gradually enlarged or reduced, the electronic device 101 may switch the camera for acquiring the image displayed on the display to other camera. For example, while displaying an image acquired through the first camera 332-1 at 1.0× magnification and performing a zoom operation for zooming in at 4.0× magnification, if the magnification of the screen displayed on the display reaches 2.0× magnification, the electronic device 101 may switch the image displayed by acquiring through the first camera 332-1 to the image acquired through the second camera 332-2. Herein, the second camera 332-2 may be a camera supporting a smaller angle of view (or, having a longer focal length, or higher magnification) than the first camera 332-1. The threshold for switching the camera may be set differently depending on the characteristics of the cameras included in the electronic device 101.

Since the positions of the cameras are different in switching the cameras used to acquire images displayed on the display or stored as a video, the position of the subject appearing in the image may instantly move to a different position. However, the position of the subject appearing in the image may be maintained, by switching the camera while the position of the lens (or other optical system or image sensor) included in at least one camera is moved by the operation of the OIS module. Alternatively, if switching the cameras several times, at least one of the direction or the distance in which the position of the subject moves may remain constant at every camera switching. Thus, since more continuous images are provided, it is possible to reduce difference felt by the user due to the camera switching from the screen displayed during the zoom operation.

Hereinafter, a center position of the lens while the lens is not moved (no offset) by the OIS module of the camera may be referred to as the camera position for convenience of explanation. However, the definition of the camera position is not limited thereto.

In addition, the movement position of the lens and the position of the shape of the subject within the image may be exaggerated for convenience of explanation. For example, if the movement position of the lens presented in the disclosure is out of a movement range by the OIS module, the lens may be moved within the movement range by the OIS module.

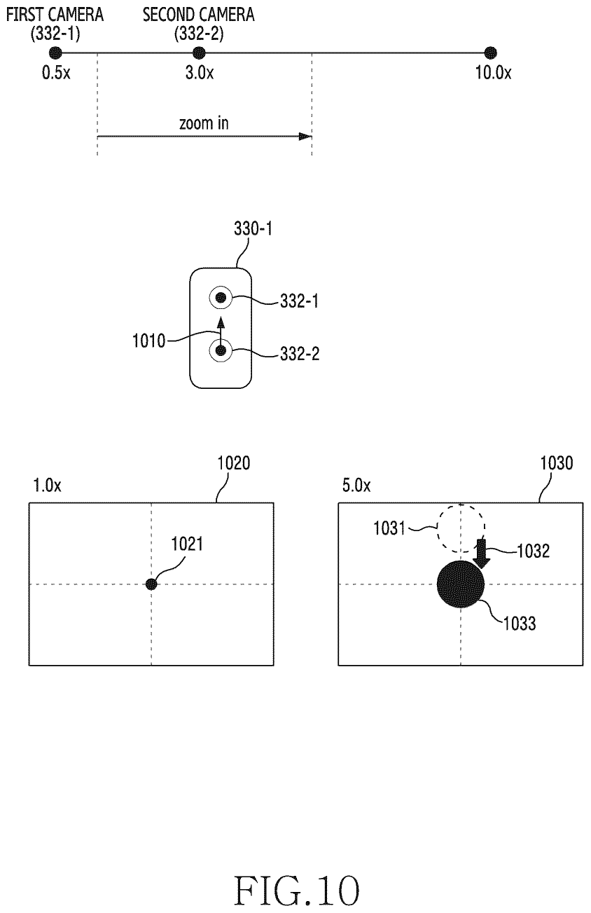

FIG. 10 is a diagram illustrating an electronic device switches a camera used to acquire an image from a first camera to a second camera in response to receiving a zoom-in input according to an embodiment of the disclosure.

Referring to FIG. 10, the second camera 332-2 may be a camera supporting a narrower field of view than the first camera 332-1. The second camera 332-2 may be referred to as a camera with a longer focal length or a camera with higher magnification than the first camera 332-1.

FIG. 10 illustrates performing a zoom operation to zoom in at 5.0× magnification while displaying a preview image at 1.0× magnification using a first camera 332-1. An image 1020 is an example of the preview image in which the shape of the subject is presented at a position 1021 at 1.0× magnification.

While performing the zoom-in operation, the electronic device 101 may control the OIS module of the second camera 332-2 to move the lens of the second camera 332-2 disposed in the camera area 330-1 to the position of the first camera 332-1 or in a direction 1010 toward the position of the lens of the first camera 332-1. If the magnification of the preview image reaches 3.0× during the zoom-in operation, the electronic device 101 may switch the preview image to an image acquired through the second camera 332-2. An image 1030 is an example of the preview image displayed based on the image acquired through the second camera 332-2. If the preview image is displayed using the second camera 332-2 while the lens of the second camera 332-2 is not moved, the shape of the subject may be displayed at a position 1031. However, if an image is acquired through the second camera 332-2 while the lens of the second camera 332-2 is moved in the direction 1010 toward the first camera 332-1, the shape of the subject may be displayed at a position 1033 moved in a direction 1032 toward the position 1021 of the shape of the subject in the image 1020.

Contrary to FIG. 10, in a zoom-out operation from 5.0× magnification to 1.0× magnification, the camera may be switched to the first camera 332-1 while the lens of the first camera 332-1 is moved in a direction toward the second camera 332-2.

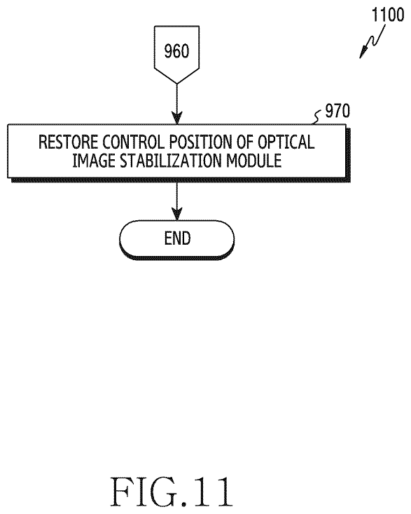

FIG. 11 is a flowchart 1100 illustrating a process after a zoom operation of an electronic device according to an embodiment of the disclosure.

Referring to FIG. 11, after performing the zoom operation in operation 960, the magnification of the image displayed on the display may be maintained if the zoom operation is completed. While the magnification of the image is maintained, the electronic device 101 may move the control position of the OIS module from the position moved in operation 950 with no offset in operation 970. Since the electronic device 101 needs a margin for moving the optical system or the image sensor by the OIS module to provide the OIS function, the electronic device 101 may restore the control position of the OIS module after operation 960.

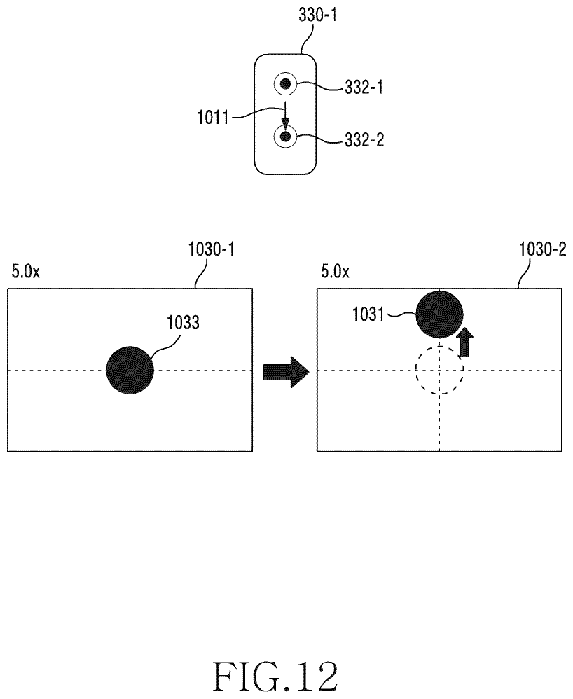

FIG. 12 is a diagram illustrating an operation after a zoom operation of an electronic device according to an embodiment of the disclosure.

Referring to FIG. 12, if the zoom operation is finished with the lens of the second camera 332-2 moved toward the first camera 332-1 while the zoom operation is performed, the electronic device 101 may move the lens of the second camera 322-2 in a direction 1011 toward a position with no offset. An image 1030-1 is an example of the shape of the subject appearing at a position 1033 if the zoom operation is finished. If restoring the control position of the OIS module of the second camera 322-2, the shape of the subject may move to a position 1031 opposite to the movement direction of the lens as shown in an image 1030-2.

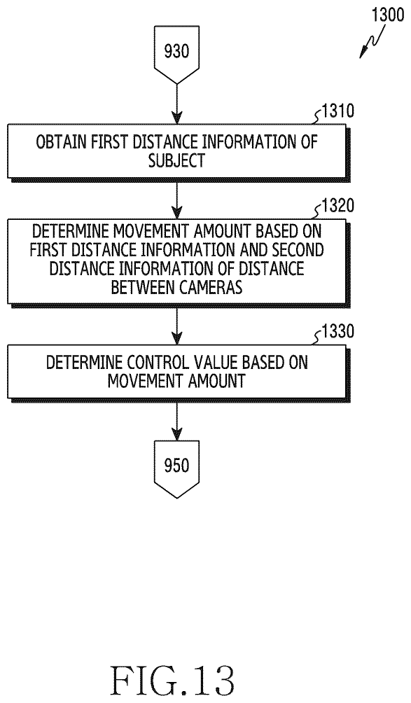

FIG. 13 is a flowchart 1300 illustrating a process for an electronic device to determine a control value for controlling an OIS module according to an embodiment of the disclosure.

Referring to FIG. 13, in operation 1310, the electronic device 101 may obtain first distance information of the subject. The configuration for obtaining the first distance information of the subject may be implemented in various manners. For example, the electronic device 101 may obtain the first distance information of the subject using at least one of a TOF sensor, a laser sensor, a depth sensor, a range sensor, a photo diode (PD) sensor pixel, or a stereo camera.

In operation 1320, the electronic device 101 may determine a movement amount corresponding to the distance to move the lens based on the first distance information and second distance information relating to the distance between the cameras. The second distance information related to the distance between the cameras may be stored in the electronic device 101. Herein, the second distance information related to the distance between the cameras may indicate a gap between positions of two cameras used if the camera used to obtain the preview image is switched during the zoom operation. As a value indicated by the first distance information increases, the determined movement amount may decrease.

In operation 1330, the electronic device 101 may determine at least one control value based on the determined movement amount. For example, the electronic device 101 may determine at least one control value for controlling the OIS module such that the lens moves over a longer distance as the determined movement amount increases.

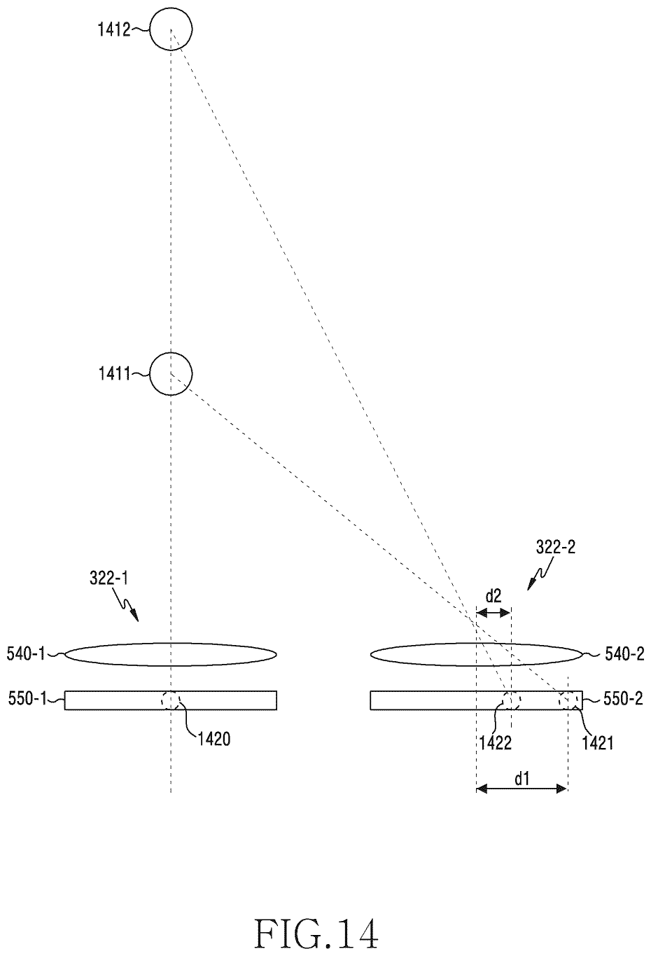

FIG. 14 is a diagram for illustrating position movement of a subject image in an image based on a distance to the subject according to an embodiment of the disclosure.

Referring to FIG. 14, a first subject 1411 is located closer to the electronic device 101 (or the camera of the electronic device 101) than a second subject 1412. FIG. 14 shows that shapes of the first subject 1411 and the second subject 1412 pass through a lens 540-1 of the first camera 332-1 and are formed at a position 1420 of an image sensor 550-1.

The shape of the first subject 1411 may be formed at a position 1421 on an image sensor 550-2 of the second camera 332-2 positioned away from the first camera 332-1. The shape of the second subject 1412 formed on the image sensor 550-2 may appear at a position 1422. The electronic device 101 may move a lens 540-2 to move the shape by a distance dl so as to correct the shape of the first subject 1411 presented on the image sensor 550-2 of the second camera 332-2 to a position corresponding to the position 1420 of the image sensor 550-1 of the first camera 332-1. The electronic device 101 may move the lens 540-2 based on a movement amount corresponding to d2 which is smaller than dl to correct the shape of the second subject 1412 presented on the image sensor 550-2 of the second camera 332-2 to the position corresponding to the position 1420.

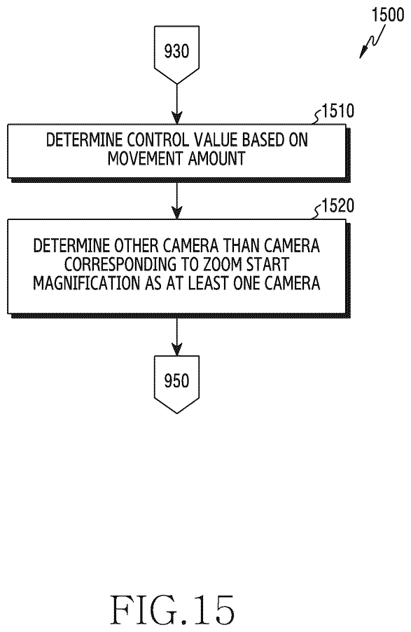

FIG. 15 is a flowchart 1500 illustrating a process in which an electronic device determines at least one camera according to an embodiment of the disclosure.

Hereinafter, the magnification of the image displayed on the display at the start of the zoom operation (hereafter, referred to as a zoom start time) may be referred to as a zoom start magnification. The magnification of the image displayed on the display at the end of the zoom operation (hereafter, referred to as a zoom end time) may be referred to as a zoom target magnification.

Referring to FIG. 15, in operation 1510, the electronic device 101 may identify cameras corresponding to a zoom interval from the zoom start magnification to the zoom target magnification corresponding to the user input requesting the zoom operation. If the magnification reaches the threshold while performing the zoom operation, the electronic device 101 may switch the camera to acquire an image to be displayed on the display. Based on the zoom interval, the electronic device 101 may identify the camera acquiring the image to be displayed on the display at the start of the zoom operation and the cameras to be used to acquire the image after the switching.

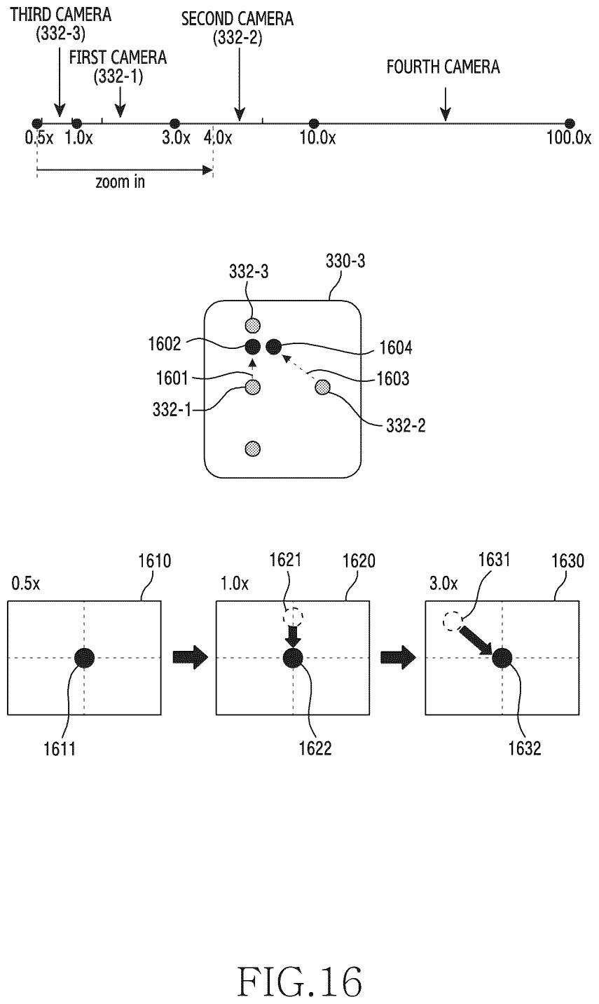

FIG. 16 is a diagram illustrating a method for an electronic device to move a lens of at least one camera while performing a zoom-in operation to change magnification according to an embodiment of the disclosure.

Referring to FIG. 16, the electronic device 101 may receive a user input for performing a zoom-in operation at 4.0× magnification while displaying a preview image at 0.5× magnification according to an embodiment of the disclosure. The electronic device 101 may acquire an image to be displayed through the third camera 332-3 while displaying the preview image at 0.5× magnification. While the zoom-in operation is performed, the electronic device 101 may switch the camera for acquiring the image to be displayed to the first camera 322-1 in response to the magnification reaching 1.0×. Next, in response to the magnification reaching 3.0× magnification, the electronic device 101 may switch the camera for acquiring the image to be displayed to the second camera 322-2. Hence, the electronic device 101 may identify the first camera 332-1, the second camera 332-2 and the third camera 332-3 among the cameras in the camera area 330-3, in response to the user input.

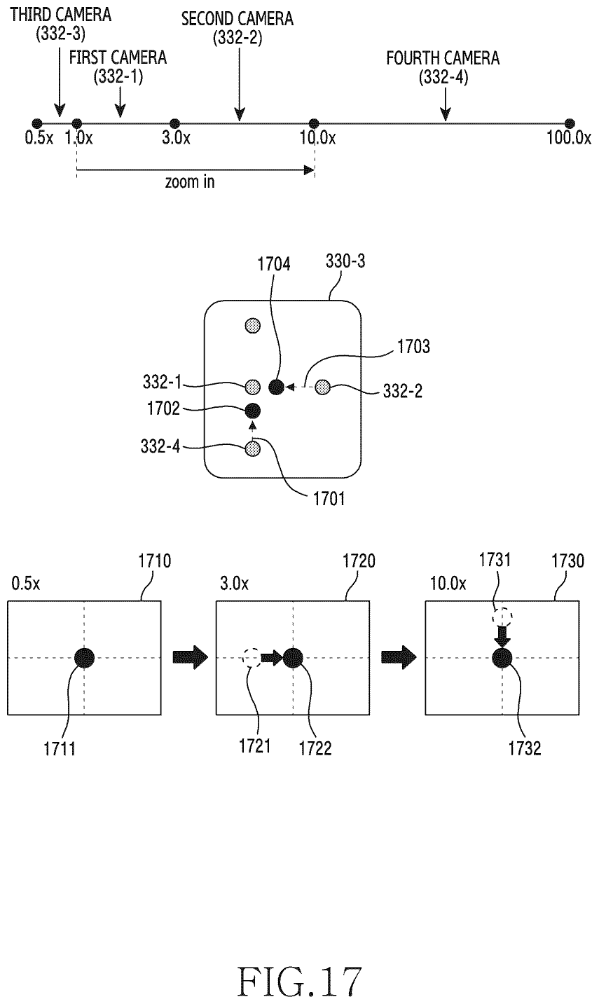

FIG. 17 is a diagram illustrating a method for an electronic device to move a lens of at least one camera while performing a zoom-in operation for different magnification according to an embodiment of the disclosure.

Referring to FIG. 17, the electronic device 101 may receive a user input for performing a zoom-in operation at 10.0× magnification while displaying a preview image at 1.0× magnification according to an embodiment of the disclosure. While displaying the preview image at 1.0× magnification, the electronic device 101 may obtain a screen to be displayed through the first camera 332-1. While performing the zoom-in operation, the electronic device 101 may switch the camera acquiring the image to be displayed to the second camera 332-2 in response to the magnification reaching 3.0×. Next, in response to the magnification reaching 10.0×, the electronic device 101 may switch the camera for acquiring the image to be displayed to the fourth camera 332-4. Thus, in response to the user input, the electronic device 101 may identify the first camera 331-1, the second camera 332-2 and the fourth camera 332-4 among the cameras in the camera area 330-3.

In operation 1520, the electronic device 101 may determine other camera than the camera corresponding to the zoom start magnification among the cameras identified in operation 1510, as at least one camera. In operation 950, the electronic device 101 may determine at least one control value for moving the lens of each of the at least one camera determined in operation 1520 toward the position of the camera corresponding to the zoom start magnification.

For example, FIG. 16 shows an example where the zoom operation interval starts from 0.5× magnification and changes to 4.0× magnification. Referring to FIG. 16, the electronic device 101 may determine the first camera 332-1 and the second camera 332-2 excluding the third camera 332-3 among the identified cameras, as cameras to be controlled for image correction. The electronic device 101 may control the OIS module of the third camera 332-3 to move the lens of the first camera 332-1 in a direction 1601 toward the position of the third camera 332-3 corresponding to the zoom start magnification. Alternatively, the electronic device 101 may control the lens of the first camera 332-1 to move to a position 1602. The electronic device 101 may determine a first control value for moving the lens in the direction 1601 or moving the lens to the position 1602. The electronic device 101 may control the OIS module of the second camera 332-2 to move the lens of the second camera 332-2 in a direction 1603 toward the position of the third camera 332-3 corresponding to the zoom start magnification. Alternatively, the electronic device 101 may control the lens of the second camera 332-2 to move to a position 1604. The electronic device 101 may determine a second control value for moving the lens in the direction 1603 or moving the lens to the position 1604. The electronic device 101 may perform the zoom operation while moving the lenses of the first camera 332-1 and the second camera 332-2 using the OIS modules.

If displaying an image at 0.5× magnification, the electronic device 101 may display an image 1610 acquired through the third camera 332-3. The image 1610 shows the example where a subject is displayed at a position 1611. The position of the subject displayed in the images shown in the following drawings is to indicate the position of the subject presented in the image, and are depicted without considering the magnification of the image. While performing the zoom operation, if the magnification of the image displayed on the display reaches 1.0×, the electronic device 101 may switch the screen displayed on the display to an image 1620 acquired through the first camera 332-1. If the image is acquired through the first camera 332-1 without moving the lens of the first camera 332-1, the shape of the subject may be presented at a position 1621 of the image 1620. However, the shape of the subject may be presented at a position 1622 corresponding to the position 1611 in the image 1620 acquired through the first camera 332-1 while the lens of the first camera 332-1 is moved. While performing the zoom operation, if the magnification of the image displayed on the display reaches 3.0×, the electronic device 101 may switch the screen displayed on the display to an image 1630 acquired through the second camera 332-2. If the image is acquired through the second camera 332-2 without moving the lens of the second camera 332-2, the shape of the subject may be presented at a position 1631. However, the shape of the subject may present at a position 1632 corresponding to the position 1622 in the image 1630 acquired through the second camera 332-2 while the lens of the second camera 332-2 is moved.

As another example, FIG. 17 shows an example in which the zoom operation interval starts at 1.0× magnification and changes to 10.0× magnification according to an embodiment of the disclosure. Referring to FIG. 17, the electronic device 101 may determine the second camera 332-2 and the fourth camera 332-4 excluding the first camera 332-1 among the identified cameras, as cameras to be controlled for image correction. The electronic device 101 may control the lenses of the second camera 332-2 and the fourth camera 332-4 to move in directions 1701 and 1703 respectively toward the position of the first camera 332-1 corresponding to the zoom start magnification. Alternatively, the electronic device 101 may control the lenses of the second camera 332-2 and the fourth camera 332-4 to move to positions 1702 and 1704 respectively. The electronic device 101 may perform the zoom operation while moving the lenses of the second camera 332-2 and the fourth camera 332-4 to the position of the first camera 332-1 or moving to a position close to the position of the first camera 332-1 by use of the OIS module.

If displaying an image at 1.0× magnification, the electronic device 101 may display an image 1710 acquired through the first camera 332-1. The image 1710 shows an example where the subject is displayed at a position 1711. While performing the zoom operation, if the image displayed on the display reaches 3.0×, the electronic device 101 may switch the screen displayed on the display to an image 1720 acquired through the second camera 332-2. If the image is acquired through the second camera 332-2 without moving the lens of the second camera 332-2, the shape of the subject may be presented at a position 1721 of the image 1720. However, the shape of the subject may be presented at a position 1722 corresponding to the position 1711 in the image 1720 acquired through the second camera 332-2 while the lens of the second camera 322-2 is moved. While performing the zoom operation, if the magnification of the image displayed on the display reaches 10.0×, the electronic device 101 may switch the screen displayed on the display to an image 1730 acquired through the fourth camera 332-4. If an image is acquired through the fourth camera 332-4 without moving the lens of the fourth camera 332-4, the shape of the subject may be presented at a position 1731. However, the shape of the subject may be presented at a position 1732 corresponding to the position 1722 in the image 1730 acquired through the fourth camera 332-4 while the lens of the fourth camera 332-4 is moved.

FIGS. 16 and 17 illustrate an operation of an electronic device based on a zoom-in operation, but a process shown in the flowchart 1500 of FIG. 15 may be applied in a similar manner to a zoom-out operation in which a magnification is reduced.

Referring to FIGS. 16 and 17, they illustrate the examples of performing the zoom operation using three cameras, but the process shown in the flowchart 1500 of FIG. 15 may be applied in a similar manner even to the zoom operation performed using more cameras.

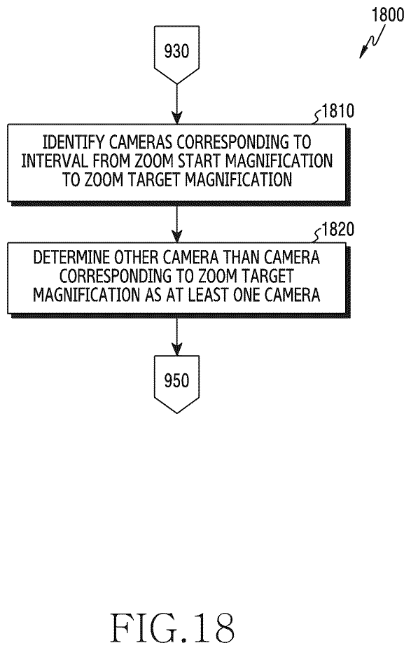

FIG. 18 is a flowchart 1800 illustrating a process in which an electronic device determines at least one camera according to an embodiment of the disclosure.

Referring to FIG. 18, in operation 1810, the electronic device 101 may identify cameras corresponding to the zoom interval from the zoom start magnification to the zoom target magnification corresponding to the user input requesting the zoom operation. In operation 1810, the electronic device 101 may identify the cameras corresponding to the zoom interval as described above in relation to operation 1510 of FIG. 15.

In operation 1820, the electronic device 101 may determine other camera than the camera corresponding to the zoom target magnification among the cameras identified in operation 1810, as at least one camera. In operation 950, the electronic device 101 may determine at least one control value to move the lens of each of the at least one camera determined in operation 1820 toward the position of the camera corresponding to the zoom target magnification.

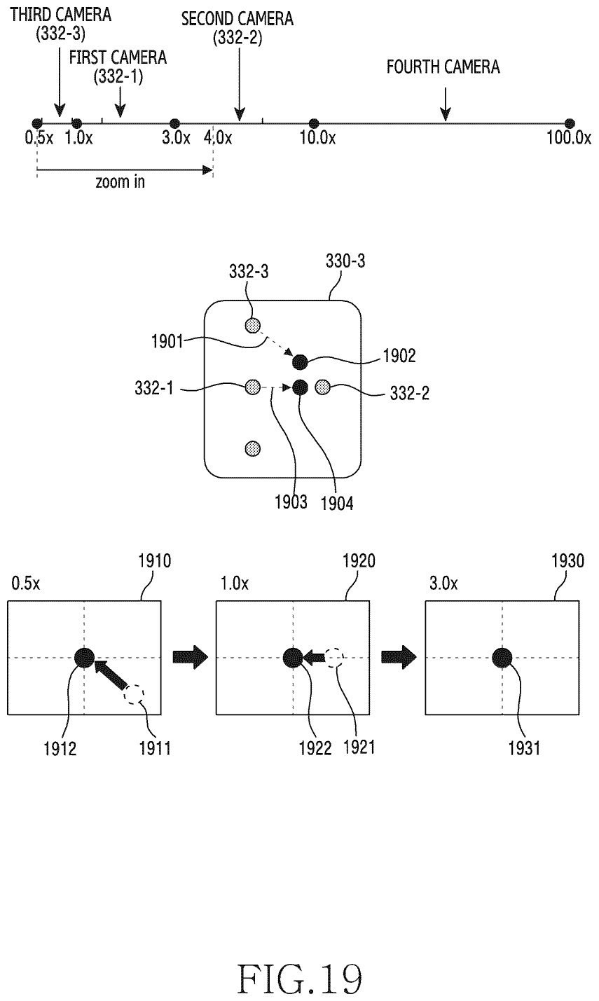

FIG. 19 illustrate a zoom operation interval starts at 0.5× magnification and changes to 4.0× magnification according to an embodiment of the disclosure.

Referring to FIG. 19, the electronic device 101 may determine the first camera 332-1 and the third camera 332-3 excluding the second camera 332-2 among the identified cameras, as cameras to control. The electronic device 101 may control the position of the lenses of the first camera 332-1 and the third camera 332-3. The electronic device 101 may control the OIS module of the second camera 332-2 to move the lens of the third camera 332-3 in a direction 1901 toward the position of the second camera 332-2 corresponding to the zoom target magnification. Alternatively, the electronic device 101 may control the OIS module to move the position of the lens of the third camera 332-3 to a position 1902. The electronic device 101 may determine a first control value for moving the lens in the direction 1901 or moving the lens to the position 1902. The electronic device 101 may control the OIS module of the first camera 332-1 to move the lens of the first camera 332-1 in a direction 1903 toward the position of the second camera 332-2 corresponding to the zoom target magnification. Alternatively, the electronic device 101 may control the lens of the first camera 332-1 to move to a position 1904. The electronic device 101 may determine a second control value for moving the lens in the direction 1903 or moving the lens to the position 1904. The electronic device 101 may perform the zoom operation while moving the lenses of the first camera 332-1 and the third camera 332-3 by use of the OIS module.

Due to the lens movement of the third camera 332-3, a position 1911 presenting the shape of the subject may move to a position 1912 in the image 1910 acquired through the third camera 332-3. If the magnification of the screen displayed on the display reaches 1.0× while the zoom operation is performed, the electronic device 101 may switch the screen displayed on the display to an image 1920 acquired through the first camera 332-1. In the image 1920, the shape of the subject may be presented at a position 1922 corresponding to the position 1912 by moving from the position 1921. If the magnification of the screen displayed on the display reaches 3.0× while the zoom operation is performed, the electronic device 101 may switch the screen displayed on the display to an image 1930 acquired through the second camera 332-2. In the image 1930, a position 1931 presenting the shape of the subject may correspond to the position 1912 and/or the position 1922.

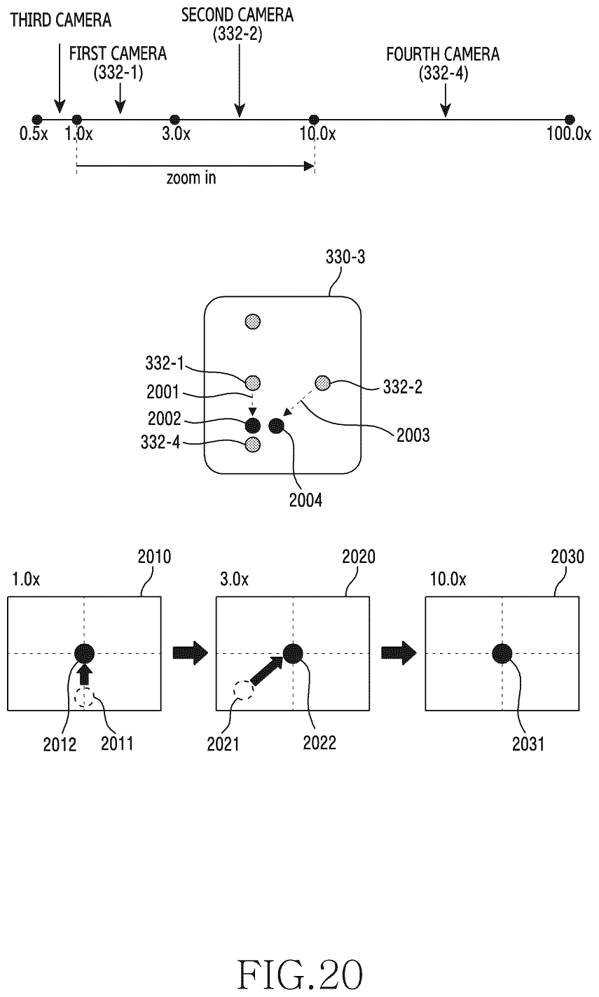

FIG. 20 is a diagram illustrating a method for an electronic device to move a lens of at least one camera while performing a zoom-in operation for different magnification according to an embodiment of the disclosure.

Referring to FIG. 20, it shows an example in which the zoom operation interval starts at 1.0× magnification and changes to 10.0× magnification. The electronic device 101 may determine the first camera 332-1 and the second camera 332-2 excluding the fourth camera 332-4 among the identified cameras, as cameras to be controlled for image correction. The electronic device 101 may control the position of the lenses of the first camera 332-1 and the second camera 332-2. The electronic device 101 may control the OIS module of the first camera 332-1 to move the lens of the first camera 332-1 in a direction 2001 toward the position of the fourth camera 332-4 corresponding to the zoom target magnification. Alternatively, the electronic device 101 may control the position of the second camera 332-2 to move to a position 2002. The electronic device 101 may determine a first control value for moving the lens in the direction 2001 or moving the lens to the position 2002. The electronic device 101 may control the OIS module of the second camera 332-2 to move the lens of the second camera 332-2 in a direction 2003 toward the position of the fourth camera 332-4 corresponding to the zoom target magnification. Alternatively, the electronic device 101 may control the lens of the second camera 332-2 to move to a position 2004. The electronic device 101 may determine a second control value for moving the lens in the direction 2003 or moving the lens to the position 2004. The electronic device 101 may perform the zoom operation while moving the lenses of the first camera 332-1 and the second camera 332-2 by use of the OIS module.

Due to the lens movement of the first camera 332-1, a position 2011 presenting the shape of the subject may move to a position 2012 in the image 2010 acquired through the first camera 332-1. If the magnification of the screen displayed on the display reaches 3.0× while the zoom operation is performed, the electronic device 101 may switch the screen displayed on the display to an image 2020 acquired through the second camera 332-2. In the image 2020, the shape of the subject may be presented at a position 2022 corresponding to the position 2012 by moving from the position 2021. If the magnification of the screen displayed on the display reaches 10.0x while the zoom operation is performed, the electronic device 101 may switch the screen displayed on the display to an image 2030 acquired through the fourth camera 332-4. A position 2031 presenting the shape of the subject in the image 2030 may correspond to the position 2012 and/or the position 2022.

FIGS. 19 and 20 have described an operation of an electronic device based on a zoom-in operation, but a process shown in the flowchart 1800 of FIG. 18 may be applied to a zoom-out operation for reducing the magnification in a similar manner.

In addition, FIGS. 19 and 20 show performing a zoom operation using three cameras, but the process shown in the flowchart 1800 of FIG. 18 may be applied in a similar manner for a zoom operation performed using more cameras.

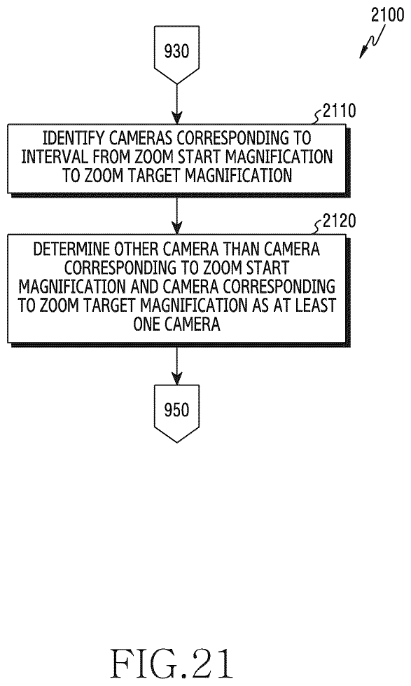

FIG. 21 is a flowchart 2100 illustrating a process in which an electronic device determines at least one camera according to an embodiment of the disclosure.

Referring to FIG. 21, in operation 2110, the electronic device 101 may identify cameras corresponding to the zoom interval from the zoom start magnification to the zoom target magnification corresponding to the user input requesting the zoom operation. In operation 2110, the electronic device 101 may identify the cameras corresponding to the zoom interval as described above in relation to operation 1510 of FIG. 15.

In operation 2120, the electronic device 101 may determine other camera than the camera corresponding to the zoom start magnification and the camera corresponding to the zoom target magnification among the cameras identified in operation 2110, as at least one camera. In operation 950, the electronic device 101 may determine at least one control value for moving the lens of each of the at least one camera determined in operation 2120 toward a straight line connecting the camera corresponding to the zoom start magnification and the camera corresponding to the zoom target magnification.

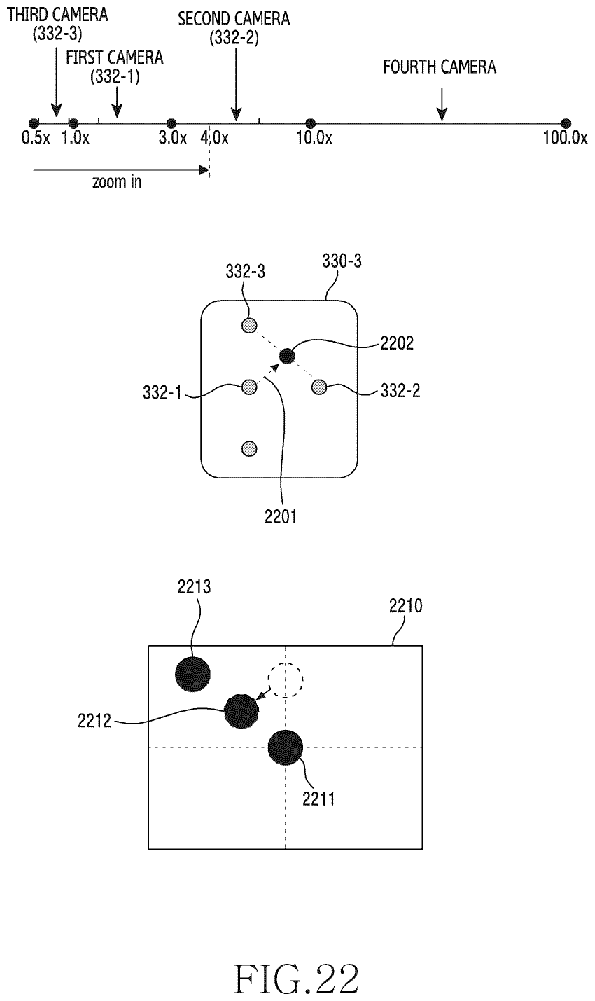

FIG. 22 is a diagram illustrating a method for an electronic device to move a lens of at least one camera while performing a zoom-in operation to change magnification according to an embodiment of the disclosure.

For example, FIG. 22 illustrates an example where the zoom operation interval starts from 0.5× magnification and changes to 4.0× magnification according to an embodiment of the disclosure.

Referring to FIG. 22, the electronic device 101 may determine the first camera 332-1 excluding the third camera 332-3 corresponding to the zoom start magnification and the second camera 332-2 corresponding to the zoom target magnification among the identified cameras, as a camera to be controlled for image correction. The electronic device 101 may control the position of the lens of the first camera 332-1. The electronic device 101 may control the OIS module of the first camera 332-1 to move the lens of the first camera 332-1 in a direction 2201 toward the straight line connecting the second camera 332-2 and the third camera 332-3. Alternatively, the electronic device 101 may control the OIS module to move the position of the lens of the first camera 332-1 to a position 2202 between the second camera 332-2 and the third camera 332-3. The electronic device 101 may determine at least one control value for moving the lens in the direction 2201 or moving the lens to the position 2202. The electronic device 101 may perform the zoom operation while moving the lens of the first camera 332-1 by use of the OIS module.

An image 2210 is an example showing a position 2211 presenting the subject in the image captured through the third camera 332-3, a position 2212 presenting the subject in the image captured through the first camera 332-1, and a position 2213 presenting the subject in the image captured through the second camera 332-2 which are overlaid. While performing a zoom operation, if the magnification of the screen displayed based on the image acquired through the third camera 332-3 reaches 1.0×, the electronic device 101 may switch the screen displayed on the display to the image acquired through the first camera 332-1. Next, if the magnification of the screen displayed on the display reaches 3.0× while performing the zoom operation, the electronic device 101 may switch the screen displayed on the display to the image acquired through the second camera 332-2. Hence, each time the camera for displaying the screen is switched, the subject may move from the position 2211 to the position 2212 via the position 2213 while performing the zoom operation. The position 2212 may be arranged to reduce displacement of the subject position change in the camera switching process. For example, the position 2212 may be a position moved in a direction toward a line segment connecting the position 2211 and the 2213. The position 2212 may be disposed between the position 2211 and the position 2213. Thus, movement of the position presenting the shape of the subject may be reduced compared to no position correction of the first camera 332-1. In addition, the movement direction of the position presenting the shape of the subject may remain constant compared to no position correction of the first camera 332-1.

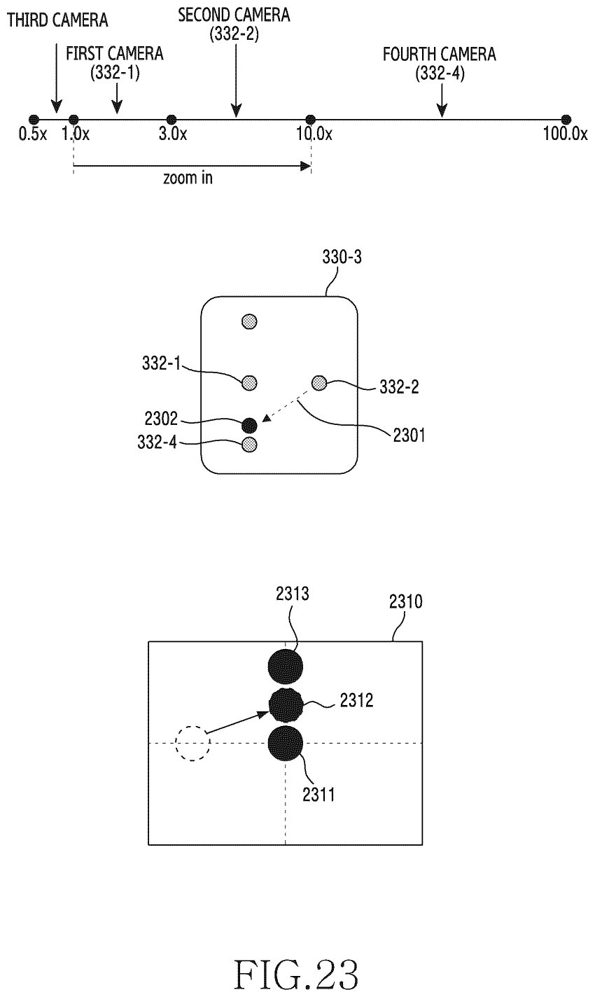

FIG. 23 is a diagram illustrating a method for an electronic device to move a lens of at least one camera while performing a zoom-in operation for different magnification according to an embodiment of the disclosure.

As another example, FIG. 23 shows an example in which the zoom operation interval starts from 1.0× magnification and changes to 10.0× magnification according to an embodiment of the disclosure.

Referring to FIG. 23, the electronic device 101 may determine the second camera 332-2 excluding the first camera 332-1 corresponding to the zoom start magnification and the fourth camera 332-4 corresponding to the zoom target magnification among the identified cameras, as a camera to be controlled for image correction. The electronic device 101 may control the position of the lens of the first camera 332-2. The electronic device 101 may control the OIS module of the second camera 332-2 to move the lens of the second camera 332-2 in a direction 2301 toward a straight line connecting the first camera 332-1 and the fourth camera 332-4. Alternatively, the electronic device 101 may control the OIS module to move the position of the lens of the second camera 332-2 to a position 2302 between the first camera 332-1 and the fourth camera 332-4. The electronic device 101 may determine at least one control value for moving the lens of the second camera 332-2 in the direction 2301 or moving the lens to the position 2302. The electronic device 101 may perform the zoom operation while moving the lens of the second camera 332-2 by use of the OIS module.

An image 2310 is an example showing a position 2311 presenting the subject in the image captured through the first camera 332-1, a position 2312 presenting the subject in the image captured through the second camera 332-2 and a position 2313 presenting the subject in the image captured through the fourth camera 332-4 which are overlaid. While performing the zoom operation, if the magnification of the screen displayed based on the image acquired through the first camera 332-1 reaches 3.0×, the electronic device 101 may switch the screen displayed on the display to the image acquired through the second camera 332-1. Next, if the magnification of the screen displayed on the display reaches 10.0× while performing the zoom operation, the electronic device 101 may switch the screen displayed on the display to the image acquired through the fourth camera 332-4. Hence, each time the camera for displaying the screen is switched, the subject may move from the position 2311 to the position 2313 via the position 2312 while performing the zoom operation.

FIGS. 22 and 23 describe an operation of an electronic device based on a zoom-in operation, but a process shown in the flowchart 2100 of FIG. 21 may be applied in a similar manner to the zoom-out operation for reducing the magnification.

In addition, FIGS. 22 and 23 illustrate the example of performing the zoom operation using three cameras, but the process shown in the flowchart 2100 of FIG. 21 may be applied similarly to a zoom operation performed using more cameras.

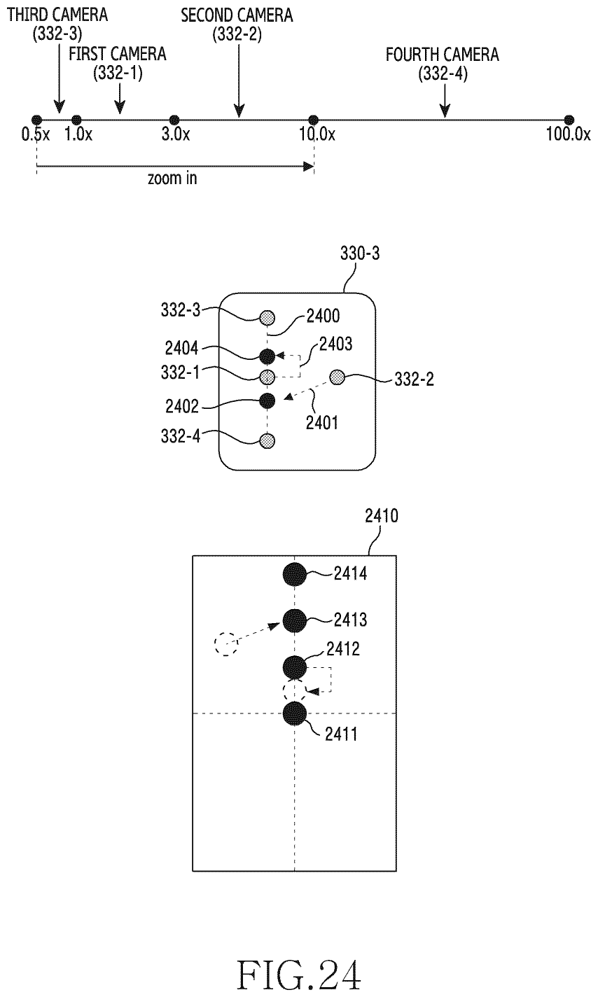

FIG. 24 is a diagram illustrating a method for an electronic device to move a lens of at least one camera while performing a zoom-in operation using four cameras according to an embodiment of the disclosure.

Referring to FIG. 24, it illustrates the example where the zoom start magnification is 0.5× and the zoom target magnification is 10.0×.

The electronic device 101 may sequentially use images acquired through the third camera 332-3, the first camera 332-1, the second camera 332-2 and the fourth camera 332-4 to perform the zoom operation shown in FIG. 24. Accordingly, in operation 2110 of FIG. 21, the electronic device 101 may identify the first camera 332-1, the second camera 332-2, the third camera 332-3 and the fourth camera 332-4 disposed in the camera area 330-3.

In operation 2120, the electronic device 101 may determine the first camera 332-1 and the second camera 332-2 excluding the third camera 332-3 corresponding to the zoom start magnification and the fourth camera 332-4 corresponding to the zoom target magnification as the cameras to be controlled for the image correction. The electronic device 101 may control the position of the lens of the second camera 332-2 in a direction 2401 moving to a position 2402 on a straight line connecting the third camera 332-3 corresponding to the zoom start magnification and the fourth camera 332-4 corresponding to the zoom target magnification. The electronic device 101 may control the position of the lens of the first camera 332-1 in a direction moving to a position 2404 on a straight line connecting the third camera 332-3 corresponding to the zoom start magnification and the fourth camera 332-4 corresponding to the zoom target magnification.

An image 2410 is an example showing a position 2411 presenting the subject in the image captured through the third camera 332-3, a position 2412 presenting the subject in the image captured through the first camera 332-1, a position 2413 presenting the subject in the image captured through the second camera 332-2 and a position 2414 presenting the subject in the image captured through the fourth camera 332-4 which are overlaid. The position 2404 to which the lens of the first camera 332-1 is to be moved and the position 2402 to which the lens of the second camera 332-2 is to be moved may be positions for making intervals between the positions 2411, 2412, 2413, and 2414 presenting the shape of the subject similar to each other or constant.

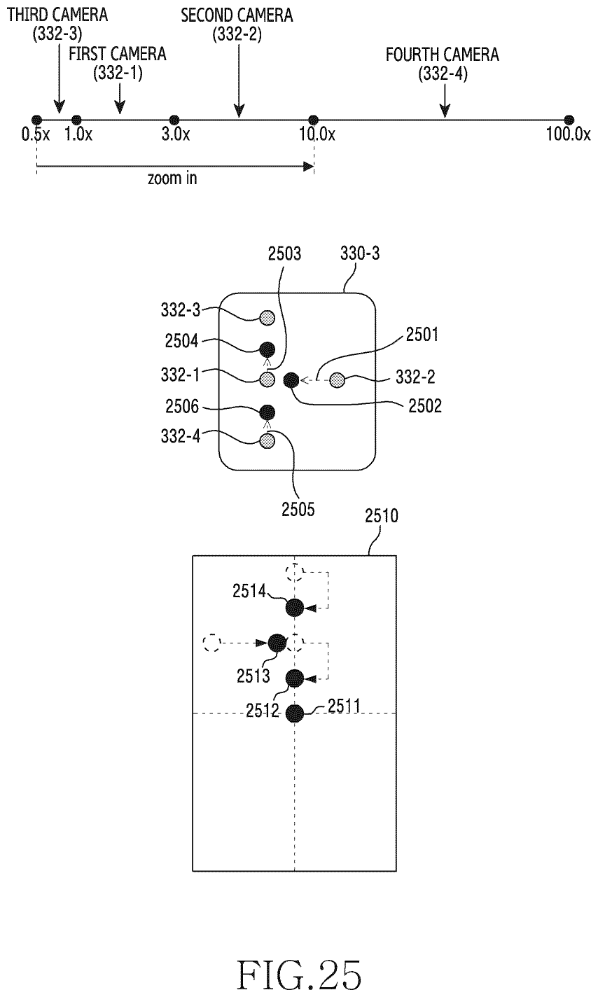

FIG. 25 is a diagram illustrating a method for an electronic device to move a lens of at least one camera while performing a zoom-in operation using four cameras according to an embodiment of the disclosure.

Referring to FIG. 25, the electronic device 101 may sequentially use images acquired through the third camera 332-3, the first camera 332-1, the second camera 332-2 and the fourth camera 332-4 to perform the zoom operation. Accordingly, the electronic device 101 may identify the first camera 332-1, the second camera 332-2, the third camera 332-3 and the fourth camera 332-4 disposed in the camera area 330-3.

The electronic device 101 may determine a position 2506 to which the lens of the fourth camera 332-4 corresponding to the zoom target magnification among the identified cameras is moved in a direction 2505 toward the position of the third camera 332-3 corresponding to the zoom start magnification. The position 2506 may be a position moved in the direction 2505 within the operation range of the OIS module of the fourth camera 332-4.

The electronic device 101 may move the lens of the first camera 332-1 in a direction 2503 toward a position 2504 on a straight line connecting the position of the third camera 332-3 corresponding to the zoom start magnification and the position 2506. The electronic device 101 may move the lens of the second camera 332-2 to a position 2502 in a direction 2501 toward the straight line connecting the position of the third camera 332-3 and the position 2506.

An image 2510 is an example showing a position 2511 presenting the subject in the image captured through the third camera 332-3, a position 2512 presenting the subject in the image captured through the first camera 332-1, a position 2513 presenting the subject in the image captured through the second camera 332-2 and a position 2514 presenting the subject in the image captured through the fourth camera 332-4 which are overlaid. The electronic device 101 may determine the position 2502 and the position 2504 to make intervals between the positions 2511, 2512, 2513, and 2514 presenting the subject in the image similar or constant.

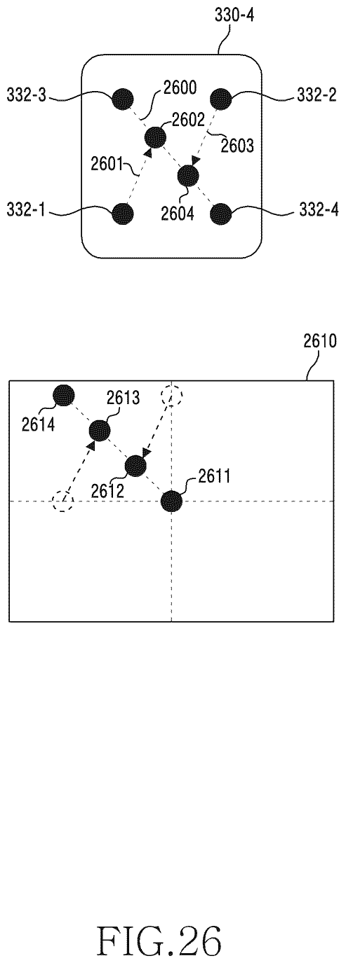

FIG. 26 is a diagram illustrating a method for an electronic device to control cameras arranged in a square while performing a zoom operation according to an embodiment of the disclosure.

Referring to FIG. 26, it illustrates that, if displaying a preview image sequentially using the cameras arranged in the square during the zoom operation in order of the third camera 332-2, the first camera 332-1, the second camera 332-2 and the fourth camera 332-4, the electronic device 101 controls the position of the lens of other camera than the camera corresponding to the zoom start magnification and the camera corresponding to the zoom target magnification as shown in FIG. 21. The electronic device 101 may move the lens of the first camera 332-1 and the lens of the second camera 332-2 in a direction 2601 toward a position 2602 and in a direction 2603 toward a position 2604 on a straight line 2600 connecting the position of the third camera 332-3 and the position of the fourth camera 332-4, respectively.

An image 2610 is an example showing a position 2611 presenting a subject in the image captured through the third camera 332-3, a position 2612 presenting the subject in the image captured through the first camera 332-1, a position 2613 presenting the subject in the image captured through the second camera 332-2 and a position 2614 presenting the subject in the image captured through the fourth camera 332-4 which are overlaid. While the zoom operation is performed, the shape of the subject displayed on the display by the electronic device 101 may move in order of the position 2611, the position 2612, the position 2613 and the position 2614.

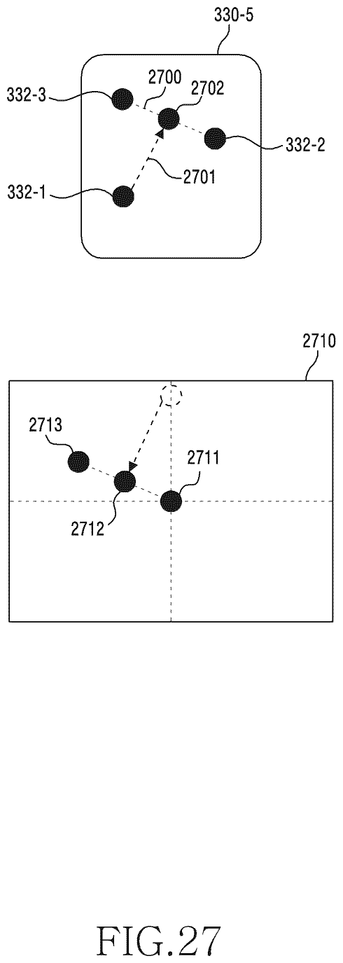

FIG. 27 is a diagram illustrating a method for an electronic device to control cameras arranged in a triangle while performing a zoom operation according to an embodiment of the disclosure.

Referring to FIG. 27, it illustrates that, if displaying a preview image sequentially using the cameras arranged in the square during the zoom operation in order of the third camera 332-2, the first camera 332-1 and the second camera 332-2, the electronic device 101 controls the position of the lens of other camera than the camera corresponding to the zoom start magnification and the camera corresponding to the zoom target magnification as shown in FIG. 21.

The electronic device 101 may move the lens of the first camera 332-1 of the camera area 330-5 in a direction 2701 toward a position 2702 on a straight line 2700 connecting the position of the second camera 332-2 and the position of the third camera 332-3.

An image 2710 is an example showing a position 2711 presenting a subject in the image captured through the third camera 332-3, a position 2712 presenting the subject in the image captured through the first camera 332-1, and a position 2713 presenting the subject captured through the second camera 332-2 which are overlaid. While the zoom operation is performed, the shape of the subject displayed on the display by the electronic device 101 may move in order of the position 2711, the position 2712 and the position 2713.

The method of operating the electronic device 101 according to the examples shown in FIGS. 15 through 27 is to explain a method for implementing one embodiment in various manners, and does not indicate the implementation as separate embodiments. The electronic device 101 may perform an operation combining at least two of the operating methods shown in the examples shown in FIGS. 15 through 27.

An electronic device according to an embodiment of the disclosure may include a plurality of cameras disposed at different positions on one side of the electronic device, a display, memory for storing instructions, and at least one processor operatively coupled to the plurality of cameras, the display, and the memory. By executing the instructions stored in the memory, the at least one processor may, while displaying an image acquired through a first camera among the plurality of cameras on the display, receive a user input corresponding to a zoom operation for changing magnification for capturing the image. The at least one processor may determine at least one camera among the plurality of cameras based on the magnification to be changed by the zoom operation. The at least one processor may determine at least one control value for controlling an optical image stabilization module of each of the at least one camera based on a position of each of the at least one camera on the one side. The at least one processor may, based on the at least one control value, control the optical image stabilization module of each of the at least one camera to move an optical system or an image sensor of each of the at least one camera in a direction of moving a position of a subject presented in the image captured by the at least one camera. The at least one processor may, while performing the zoom operation, control the display to switch an image displayed on the display from the image acquired through the first camera to an image acquired through another camera while the optical system or the image sensor of each of the at least one camera is moved based on the at least one control value.

The first camera of the electronic device according to an embodiment of the disclosure may be disposed at a first position on one side of the electronic device. The plurality of cameras may include a second camera disposed at a second position of the one side. The determined at least one camera may include the second camera. The control value may include a first control value for moving a lens included in the optical system of the second camera from the second position toward the first position.

The first camera of the electronic device according to an embodiment of the disclosure may be disposed at a first position of one side of the electronic device. The plurality of cameras of the electronic device may include a second camera disposed at a second position of the one side and a third camera disposed at a third position of the one side. The first camera, the second camera and the third camera support different angles of view (or, focal lengths or magnifications).

According to an embodiment of the disclosure, the at least one camera may include a second camera. The at least one control value may include a first control value for moving the lens of the second camera from the second position in a direction toward a line connecting the first position and the third position. The at least one processor of the electronic device may be configured to control an optical image stabilization module of the second camera based on the first control value.

According to an embodiment of the disclosure, the at least one camera determined by the electronic device may include the second camera and the third camera. The at least one control value may include a first control value for moving the lens of the second camera from the second position in a direction toward the first position and a second control value for moving the lens of the third camera from the third position in a direction toward the first position. The at least one processor be configured to control an optical image stabilization module of the second camera based on the first control value. The at least one processor be configured to control an optical image stabilization module of the third camera based on the second control value.

According to an embodiment of the disclosure, the at least one camera determined by the electronic device may include the first camera and the second camera. The at least one control value may include a first control value for moving the lens of the second camera from the second position in a direction toward the third position and a third control value for moving the lens of the first camera from the first position in a direction toward the third position. The at least one processor be configured to control an optical image stabilization module of the second camera based on the first control value. The at least one processor be configured to control an optical image stabilization module of the first camera based on the third control value.

According to an embodiment of the disclosure, the at least one processor may be configured to, while performing the zoom operation, switch the image displayed on the display to an image acquired through the second camera, with the optical system or the image sensor of each of the at least one camera moved based on the at least one control value. The at least one processor be configured to, after switching the image displayed on the display to the image acquired through the second camera, switch the image displayed on the display to an image acquired through the third camera.

According to an embodiment of the disclosure, the at least one processor may be configured to, after performing the zoom operation, control an optical image stabilization module of each of the at least one camera to move the optical system or the image sensor of the at least one camera to a position before movement based on the at least one control value.

According to an embodiment of the disclosure, the at least one processor may be configured to obtain first distance information from the electronic device to the subject. The at least one processor may be configured to determine a movement amount to move an optical system or an image sensor of each of the at least one camera based on second distance information between at least two of the plurality of cameras and the first distance information. The at least one processor may be configured to determine the at least one control value based on the movement amount.

According to an embodiment of the disclosure, the at least one processor may be configured to determine the at least one camera excluding at least a part of the plurality of cameras based on characteristics of each of the plurality of cameras.

According to an embodiment of the disclosure, the at least one processor may be configured to determine an area for cropping an image acquired through a camera excluded from the at least one camera by considering a positional relationship with the first camera. The at least one processor may be configured to display a cropped image based on the determined area through the display.

A method of operating an electronic device according to an embodiment of the disclosure may include, while displaying an image acquired through a first camera among a plurality of cameras on a display, receiving a user input corresponding to a zoom operation for changing magnification for capturing the image, determining at least one camera among the plurality of cameras based on the magnification to be changed by the zoom operation, determining at least one control value for controlling an optical image stabilization module of each of the at least one camera based on a position of each of the at least one camera on the one side of the electronic device, based on the at least one control value, controlling the optical image stabilization module of each of the at least one camera to move an optical system or an image sensor of each of the at least one camera in a direction for moving a position of a subject presented in the image captured by the at least one cameral, and while performing the zoom operation, controlling the display to switch an image displayed on the display from the image acquired through the first camera to an image acquired through other camera while the optical system or the image sensor of each of the at least one camera is moved based on the at least one control value.

According to an embodiment of the disclosure, the first camera may be disposed at a first position of the one side of the electronic device. The plurality of cameras may include a second camera disposed at a second position of the one side and a third camera disposed at a third position of the one side. The first camera, the second camera and the third camera may support different angles of view.

According to an embodiment of the disclosure, the at least one camera may include a second camera. The at least one control value may include a first control value for moving the lens of the second camera from the second position in a direction toward a line connecting the first position and the third position. Controlling the optical image stabilization module of each of the at least one camera may include controlling an optical image stabilization module of the second camera based on the first control value.

According to an embodiment of the disclosure, the determined at least one camera may include the second camera and the third camera. The at least one control value may include a first control value for moving the lens of the second camera from the second position in a direction toward the first position and a second control value for moving the lens of the third camera from the third position in a direction toward the first position. Controlling the optical image stabilization module of each of the at least one camera may include controlling an optical image stabilization module of the second camera based on the first control value, and controlling an optical image stabilization module of the third camera based on the second control value.

According to an embodiment of the disclosure, the determined at least one camera may include the first camera and the second camera. The at least one control value may include a first control value for moving the lens of the second camera from the second position in a direction toward the third position and a third control value for moving the lens of the first camera from the first position in a direction toward the third position. Controlling the optical image stabilization module of each of the at least one camera may include controlling an optical image stabilization module of the second camera based on the first control value, and controlling an optical image stabilization module of the first camera based on the third control value.

According to an embodiment of the disclosure, controlling the display to switch the image displayed on the display from the image acquired through the first camera to the image acquired through other camera may include, while performing the zoom operation, switching the image displayed on the display to an image acquired through the second camera, with the optical system or the image sensor of each of the at least one camera moved based on the at least one control value. Controlling the display include, after switching the image displayed on the display to the image acquired through the second camera, switching the image displayed on the display to an image acquired through the third camera.

The method of operating the electronic device according to an embodiment of the disclosure may include, after performing the zoom operation, controlling an optical image stabilization module of each of the at least one camera to move the optical system or the image sensor of the at least one camera to a position before movement based on the at least one control value.

According to an embodiment of the disclosure, determining the at least one control value may include obtaining first distance information from the electronic device to the subject. Determining the at least one control value may include determining a movement amount to move an optical system or an image sensor of each of the at least one camera based on second distance information between at least two of the plurality of cameras and the first distance information. Determining the at least one control value may include determining the at least one control value based on the movement amount.

One or more non-transitory computer-readable storage media according to an embodiment of the disclosure may record a program for, while displaying an image acquired through a first camera among a plurality of cameras on a display, receiving a user input corresponding to a zoom operation for changing magnification for capturing the image. The operations include determining at least one camera among the plurality of cameras based on the magnification to be changed by the zoom operation, determining at least one control value for controlling an optical image stabilization module of each of the at least one camera based on a position of each of the at least one camera on the one side of the electronic device, based on the at least one control value, controlling the optical image stabilization module of each of the at least one camera to move an optical system or an image sensor of each of the at least one camera in a direction for moving a position of a subject presented in the image captured by the at least one cameral, while performing the zoom operation, control the display to switch an image displayed on the display from the image acquired through the first camera to an image acquired through other camera while the optical system or the image sensor of each of the at least one camera is moved based on the at least one control value.

If a part of an image is cropped and displayed to correct an error in the image which occurs due to differences of arrangement positions of cameras switched during a zoom operation, image quality of a screen displayed during the zoom operation may deteriorate.

An electronic device and its operating method according to embodiments of the disclosure may reduce image quality deterioration even if the camera is switched during the zoom operation and reduce unnatural positional movement of a subject due to the camera switching.

Effects obtainable from the disclosure are not limited to the above-mentioned effects, and other effects which are not mentioned may be clearly understood by those skilled in the art of the disclosure through the following descriptions.

The methods according to the embodiments described in the claims or the specification of the disclosure may be implemented in software, hardware, or a combination of hardware and software.

In software implementation, a computer-readable storage medium storing one or more programs (software modules) may be provided. One or more programs stored in the computer-readable storage medium may be configured for execution by one or more processors of an electronic device. One or more programs may include instructions for controlling an electronic device to execute the methods according to the embodiments described in the claims or the specification of the disclosure.

Such a program (software module, software) may be stored to random access memory (RAM), non-volatile memory including flash memory, read only memory (ROM), electrically erasable programmable ROM (EEPROM), magnetic disc storage device, CD-ROM, digital versatile discs (DVDs) or other optical storage devices, and a magnetic cassette. Alternatively, it may be stored to memory combining part or all of them. In addition, a plurality of memories may be included.

In addition, the program may be stored in an attachable storage device accessible via a communication network, such as Internet, intranet, local area network (LAN), wide LAN (WLAN), or storage area network (SAN), or a communication network by combining these networks. Such a storage device may access a device which executes an embodiment of the disclosure through an external port. In addition, a separate storage device on the communication network may access the device which executes an embodiment of the disclosure.

In the specific embodiments of the disclosure, the component included in the disclosure is expressed in a singular or plural form. However, the singular or plural expression is appropriately selected according to a proposed situation for the convenience of explanation, the disclosure is not limited to a single component or a plurality of components, the components expressed in the plural form may be configured as a single component, and the components expressed in the singular form may be configured as a plurality of components.

In addition, a term, such as “unit” or “module” in the disclosure may be a hardware component, such as a processor or a circuit, and/or a software component executed by a hardware component, such as a processor.

“unit” and “module” may be stored in an addressable storage medium and implemented by a program executable by the processor. For example, “unit” and “module” may be implemented by components, such as software components, object-oriented software components, class components and task components, processes, functions, attributes, procedures, sub-routines, segments of program code, drivers, firmware, microcode, circuitry, data, databases, data structures, tables, arrays and variables.

Specific implementations described in this disclosure are merely embodiments of the disclosure, and are not intended to limit the scope of the disclosure in any way. For the sake of brevity of the specification, disclosure of electronic configurations of the related art, control systems, software, and other functional aspects of the systems may be omitted.

In addition, in the disclosure, “including at least one of a, b, or c” may indicate “including a alone, including b alone, including c alone, including a and b, including b and c, including a and c, or including all of a, b, and c”.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a plurality of cameras disposed at different positions on one side of the electronic device;
a display;
memory storing one or more computer programs; and
one or more processors communicatively coupled to the plurality of cameras, the display, and the memory,
wherein the one or more computer programs include computer-executable instructions that, when executed by the one or more processors individually or collectively, cause the electronic device to:
while displaying an image acquired through a first camera among the plurality of cameras on the display, receive a user input corresponding to a zoom operation for changing magnification for capturing the image,
determine at least one camera among the plurality of cameras based on the magnification to be changed by the zoom operation,
determine at least one control value for controlling an optical image stabilization module of each of the at least one camera based on a position of each of the at least one camera on the one side,
based on the at least one control value, control the optical image stabilization module of each of the at least one camera to move an optical system or an image sensor of each of the at least one camera in a direction of moving a position of a subject presented in the image captured by the at least one camera, and
while performing the zoom operation, control the display to switch an image displayed on the display from the image acquired through the first camera to an image acquired through another camera while the optical system or the image sensor of each of the at least one camera is moved based on the at least one control value.

2. The electronic device of claim 1,
wherein the first camera is disposed at a first position on one side of the electronic device,
wherein the plurality of cameras further comprises a second camera disposed at a second position of the one side,
wherein the determined at least one camera comprises the second camera, and
wherein the control value comprises a first control value for moving a lens included in the optical system of the second camera from the second position toward the first position.

3. The electronic device of claim 2,
wherein the first camera is disposed at a first position of one side of the electronic device,
wherein the plurality of cameras comprises a second camera disposed at a second position of the one side and a third camera disposed at a third position of the one side, and
wherein the first camera, the second camera and the third camera support different angles of view.

4. The electronic device of claim 3,
wherein the at least one camera comprises a second camera,
wherein the at least one control value comprises a first control value for moving the lens of the second camera from the second position in a direction toward a line connecting the first position and the third position, and
wherein the one or more computer programs further include computer-executable instructions that, when executed by the one or more processors individually or collectively, cause the electronic device to control an optical image stabilization module of the second camera based on the first control value.

5. The electronic device of claim 3,
wherein the determined at least one camera comprises the second camera and the third camera,
wherein the at least one control value comprises:
a first control value for moving the lens of the second camera from the second position in a direction toward the first position, and
a second control value for moving the lens of the third camera from the third position in a direction toward the first position, and
wherein the one or more computer programs further include computer-executable instructions that, when executed by the one or more processors individually or collectively, cause the electronic device to control an optical image stabilization module of the second camera based on the first control value, and controls an optical image stabilization module of the third camera based on the second control value.

6. The electronic device of claim 3,
wherein the determined at least one camera comprises the first camera and the second camera,
wherein the at least one control value comprises:
a first control value for moving the lens of the second camera from the second position in a direction toward the third position, and
a third control value for moving the lens of the first camera from the first position in a direction toward the third position, and
wherein the one or more computer programs further include computer-executable instructions that, when executed by the one or more processors individually or collectively, cause the electronic device to control an optical image stabilization module of the second camera based on the first control value, and controls an optical image stabilization module of the first camera based on the third control value.

7. The electronic device of claim 6, wherein the one or more computer programs further include computer-executable instructions that, when executed by the one or more processors individually or collectively, cause the electronic device to:
while performing the zoom operation, switch the image displayed on the display to an image acquired through the second camera, with the optical system or the image sensor of each of the at least one camera moved based on the at least one control value, and
after switching the image displayed on the display to the image acquired through the second camera, switch the image displayed on the display to an image acquired through the third camera.

8. The electronic device of claim 1, wherein the one or more computer programs further include computer-executable instructions that, when executed by the one or more processors individually or collectively, cause the electronic device to:
after performing the zoom operation, control an optical image stabilization module of each of the at least one camera to move the optical system or the image sensor of the at least one camera to a position before movement based on the at least one control value.

9. The electronic device of claim 1, wherein the one or more computer programs further include computer-executable instructions that, when executed by the one or more processors individually or collectively, cause the electronic device to:
obtain first distance information from the electronic device to the subject,
determine a movement amount to move an optical system or an image sensor of each of the at least one camera based on second distance information between at least two of the plurality of cameras and the first distance information, and
determine the at least one control value based on the movement amount.

10. The electronic device of claim 1, wherein the one or more computer programs further include computer-executable instructions that, when executed by the one or more processors individually or collectively, cause the electronic device to:
determine the at least one camera excluding at least a part of the plurality of cameras based on characteristics of each of the plurality of cameras.

11. The electronic device of claim 10, wherein the one or more computer programs further include computer-executable instructions that, when executed by the one or more processors individually or collectively, cause the electronic device to:
determine an area for cropping an image acquired through a camera excluded from the at least one camera by considering a positional relationship with the first camera, and
display a cropped image based on the determined area through the display.

12. A method of operating an electronic device comprising a plurality of cameras disposed on one side, the method comprising:
while displaying an image acquired through a first camera among a plurality of cameras on a display, receiving, by the electronic device, a user input corresponding to a zoom operation for changing magnification for capturing the image;
determining, by the electronic device, at least one camera among the plurality of cameras based on the magnification to be changed by the zoom operation;
determining, by the electronic device, at least one control value for controlling an optical image stabilization module of each of the at least one camera based on a position of each of the at least one camera on the one side of the electronic device;
based on the at least one control value, controlling, by the electronic device, the optical image stabilization module of each of the at least one camera to move an optical system or an image sensor of each of the at least one camera in a direction for moving a position of a subject presented in the image captured by the at least one cameral; and
while performing the zoom operation, controlling, by the electronic device, the display to switch an image displayed on the display from the image acquired through the first camera to an image acquired through other camera while the optical system or the image sensor of each of the at least one camera is moved based on the at least one control value.

13. The method of claim 12,
wherein the first camera is disposed at a first position of one side of the electronic device,
wherein the plurality of cameras further comprises a second camera disposed at a second position of the one side,
wherein the determined at least one camera comprises the second camera, and
wherein the control value comprises a first control value for moving a lens included in an optical system of the second camera from the second position toward the first position.

14. The method of claim 13,
wherein the first camera is disposed at a first position of the one side of the electronic device,
wherein the plurality of cameras comprises:
a second camera disposed at a second position of the one side, and
a third camera disposed at a third position of the one side, and
wherein the first camera, the second camera and the third camera support different angles of view.

15. The method of claim 14,
wherein the at least one camera comprises a second camera,
wherein the at least one control value comprises a first control value for moving the lens of the second camera from the second position in a direction toward a line connecting the first position and the third position, and
wherein controlling the optical image stabilization module of each of the at least one camera comprises controlling an optical image stabilization module of the second camera based on the first control value.

16. The method of claim 14,
wherein the determined at least one camera comprises the second camera and the third camera,
wherein the at least one control value comprises:
a first control value for moving the lens of the second camera from the second position in a direction toward the first position, and
a second control value for moving the lens of the third camera from the third position in a direction toward the first position, and
wherein the method further comprises controlling an optical image stabilization module of the second camera based on the first control value, and controls an optical image stabilization module of the third camera based on the second control value.

17. The method of claim 14,
wherein the determined at least one camera comprises the first camera and the second camera,
wherein the at least one control value comprises:
a first control value for moving the lens of the second camera from the second position in a direction toward the third position, and
a third control value for moving the lens of the first camera from the first position in a direction toward the third position, and
wherein the method further comprises controlling an optical image stabilization module of the second camera based on the first control value, and controls an optical image stabilization module of the first camera based on the third control value.

18. The method of claim 17, further comprising:
while performing the zoom operation, switch the image displayed on the display to an image acquired through the second camera, with the optical system or the image sensor of each of the at least one camera moved based on the at least one control value; and
after switching the image displayed on the display to the image acquired through the second camera, switching the image displayed on the display to an image acquired through the third camera.

19. One or more non-transitory computer-readable storage media storing one or more computer programs including computer-executable instructions that, when executed by one or more processors of an electronic device individually or collectively, cause the electronic device to perform operations, the operations comprising:
while displaying an image acquired through a first camera among a plurality of cameras on a display, receiving, by the electronic device, a user input corresponding to a zoom operation for changing magnification for capturing the image;
determining, by the electronic device, at least one camera among the plurality of cameras based on the magnification to be changed by the zoom operation;
determining, by the electronic device, at least one control value for controlling an optical image stabilization module of each of the at least one camera based on a position of each of the at least one camera on one side of the electronic device;
based on the at least one control value, controlling, by the electronic device, the optical image stabilization module of each of the at least one camera to move an optical system or an image sensor of each of the at least one camera in a direction for moving a position of a subject presented in the image captured by the at least one camera; and
while performing the zoom operation, controlling, by the electronic device, the display to switch an image displayed on the display from the image acquired through the first camera to an image acquired through other camera while the optical system or the image sensor of each of the at least one camera is moved based on the at least one control value.

20. The one or more non-transitory computer-readable storage media of claim 19,
wherein the first camera is disposed at a first position of one side of the electronic device,
wherein the plurality of cameras further comprises a second camera disposed at a second position of the one side,
wherein the determined at least one camera comprises the second camera, and
wherein the control value comprises a first control value for moving a lens included in an optical system of the second camera from the second position toward the first position.
